(19) United States
(12) Patent Application Publication
(10) Pub. No.: US 2025/0174381 A1
(43) Pub. Date: May 29, 2025

(54) COMPOSITION CONTAINER

(71) Applicant: FUJIFILM CORPORATION, Tokyo (JP)

(72) Inventor: Tetsushi Miyata, Shizuoka (JP)

(21) Appl. No.: 19/041,046

(22) Filed: Jan. 30, 2025

Related U.S. Application Data
(63) Continuation of application No. PCT/JP2023/029692, filed on Aug. 17, 2023.

(30) Foreign Application Priority Data
Aug. 25, 2022 (JP) 2022-134369

(51) Int. Cl. H01F 1/44

(52) U.S. Cl. CPC H01F 1/447

(57) ABSTRACT

An object of the present invention is to provide a composition container in which a variation in relative magnetic permeability is less likely to occur between magnetic materials obtained in a case where a composition accommodated in the container is stirred and then gradually taken out from the container and the composition is used for producing the magnetic material each time.

The composition container of the present invention is a composition container including a container having an opening portion and a composition that is accommodated inside the container and contains magnetic particles and a liquid component and satisfies predetermined physical properties, in which a ratio of an area of the opening portion of the container to a maximum area of an inner wall surface of the container in a cross section orthogonal to a height direction of the container is 0.8 or more and 1.0 or less, and an inclination W of the inner wall surface of the container with respect to the height direction of the container at a height position of half of a height H in the container at which the composition is present is 200 or less.

### CROSS-REFERENCE TO RELATED APPLICATIONS

This application is a Continuation of PCT International Application No. PCT/JP2023/029692 filed on Aug. 17, 2023, which claims priority under 35 U.S.C. § 119(a) to Japanese Patent Application No. 2022-134369 filed on Aug. 25, 2022. The above applications are hereby expressly incorporated by reference, in their entirety, into the present application.

### BACKGROUND OF THE INVENTION

### 1. Field of the Invention

The present invention relates to a composition container.

### 2. Description of the Related Art

With performance enhancement and miniaturization of electronic devices, a degree of integration of electronic circuits is increasing. As one of materials for improving the degree of integration, there is a composition containing magnetic particles. Since a magnetic material can be mounted in any shape by using such a composition, the miniaturization and the performance enhancement of the electronic devices are easily achieved as compared with a method in the related art, in which an individual piece of the magnetic material is disposed on a chip.

For example, JP2017-043749A discloses a composition containing a predetermined magnetic powder.

### SUMMARY OF THE INVENTION

The present inventors have conducted studies on the composition described in JP2017-043749A, and have found that, a variation in relative magnetic permeability may occur between magnetic materials obtained in a case where the composition accommodated in a container is stirred and then gradually taken out from the container (for example, the composition is gradually taken out from the liquid level side toward the bottom part of the container), and the composition is used for the producing the magnetic material each time (for example, the relative magnetic permeability may be different between the magnetic material derived from the composition taken out from the container in the initial stage and the magnetic material derived from the composition taken out from the container in the later stage).

Therefore, an object of the present invention is to provide a composition container in which a variation in relative magnetic permeability is less likely to occur between magnetic materials obtained in a case where a composition accommodated in a container is stirred and then gradually taken out from the container and the composition is used for producing the magnetic materials.

In order to achieve the above object, the inventors of the present invention carried out intensive examinations. As a result, the inventors have found that the object can be achieved by the following constitution.

[1]A composition container comprising:
a container having an opening portion; and
a composition that is accommodated inside the container and contains magnetic particles and a liquid component,
in which a viscosity of the composition measured under conditions of a temperature of 25° C. and a shear rate of 0.1 sec⁻¹ is 1 to 1,000 Pa·s,
a content of the magnetic particles having a particle diameter of 1 μm or more is 80% by volume or more with respect to a total volume of the magnetic particles,
a ratio of an area of the opening portion of the container to a maximum area of an area surrounded by a contour line of an inner wall surface of the container in a cross section orthogonal to a height direction of the container is 0.8 or more and 1.0 or less, and
an angle W of an inclination of the inner wall surface of the container with respect to the height direction of the container at a height position of half of a height H in the container at which the composition is present is 20° or less.
   [2] The composition container according to [1], in which in a volume-based cumulative particle size distribution of the magnetic particles, in a case where particle diameters of the magnetic particles corresponding to a cumulative percentage of 10% and 90% are respectively denoted by D10 and D90, D90/D10≥3.7 is satisfied, and
W, D10, and D90 satisfy Formula (C1).

cos(90−W)°×(D90/D10)²≤5.00 Formula (C1):

[3] The composition container according to [1] or [2], in which the composition container contains two or more kinds of the magnetic particles having different compositions.

[4] The composition container according to any one of [1] to [3], in which an inner volume of the container is 2 L or less.

[5] The composition container according to any one of [1] to [4], in which a void ratio calculated by Formula (C2) is 50% by volume or less.

Void ratio=(a volume of a void portion obtained by subtracting a volume occupied by the composition from the inner volume of the container/the inner volume of the container)×100 Formula (C2):

[6] The composition container according to [5], in which in a composition of an atmosphere gas in the void portion, an oxygen partial pressure (hPa) is 204 hPa or less.

[7] The composition container according to any one of [1] to [6], in which the liquid component contains a solvent, and a content of the solvent is 5.0% by mass or more with respect to a total mass of the composition.

[8] The composition container according to any one of [1] to [7], in which the magnetic particles include soft magnetic particles.

[9] The composition container according to any one of [1] to [8], in which the magnetic particles are spherical.

[10] The composition container according to any one of [1] to [9], in which the composition is a composition for forming a magnetic material.

[11] The composition container according to [10], in which the composition is a composition for forming a magnetic material that is used for forming an electronic component.

[12] The composition container according to [10], in which the composition is a composition for forming a magnetic material that is used for forming an inductor.

[13] The composition container according to [10], in which the composition is a composition for forming a magnetic material that is used for forming an antenna.

According to the present invention, it is possible to provide a composition container in which a variation in relative magnetic permeability is less likely to occur between magnetic materials obtained in a case where a composition accommodated in a container is stirred and then gradually taken out from the container and the composition is used for producing a magnetic material each time.

### BRIEF DESCRIPTION OF THE DRAWINGS

FIG. 1 is a schematic cross-sectional view showing an example of an embodiment of a composition container.

FIG. 2 is a schematic view for describing an opening area ratio.

FIG. 3 is a schematic cross-sectional view showing another example of the embodiment of the composition container.

FIG. 4 is a schematic cross-sectional view showing another example of the embodiment of the composition container.

FIG. 5 is a schematic cross-sectional view showing another example of the embodiment of the composition container.

FIG. 6 is a schematic cross-sectional view showing another example of the embodiment of the composition container.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

In notations for a group (atomic group) in the present specification, in a case where the group is cited without specifying that it is substituted or unsubstituted, the group includes both a group having no substituent and a group having a substituent as long as it does not impair the spirit of the present invention. For example, an “alkyl group” includes not only an alkyl group having no substituent (unsubstituted alkyl group), but also an alkyl group having a substituent (substituted alkyl group).

“Actinic rays” or “radiation” in the present specification means, for example, a bright line spectrum of a mercury lamp, far ultraviolet rays typified by an excimer laser, extreme ultraviolet rays (EUV light), X-rays, electron beams (EB), or the like. “Light” in the present specification means actinic ray or radiation.

Unless otherwise specified, “exposure” in the present specification encompasses not only exposure by a bright line spectrum of a mercury lamp, far ultraviolet rays typified by an excimer laser, extreme ultraviolet rays, X-rays, EUV light, or the like, but also drawing by particle beams such as electron beams and ion beams.

In the present specification, a numerical range expressed using “to” is used in a meaning of a range that includes the preceding and succeeding numerical values of “to” as the lower limit value and the upper limit value, respectively.

In the present specification, “solid content” of a composition means components forming a magnetic material. Therefore, in a case where the composition contains a solvent (such as an organic solvent and water), the “solid content” means all the components excluding the solvent. In a case where the components are components which form the magnetic material, the components are considered to be solid content even in a case where the components are liquid components.

In addition, in the present specification, a weight-average molecular weight (Mw) is a value by a gel permeation chromatography (GPC) method in terms of polystyrene.

In addition, in the present specification, for each component, unless otherwise specified, one kind of substance corresponding to each component may be used alone, or two or more kinds thereof may be used in combination. Here, in a case where two or more kinds of substances corresponding to respective components are used in combination, the content of the components indicates the total content of the substances used in combination unless otherwise specified.

### [Composition Container]

The composition container according to the embodiment of the present invention is a composition container including a container having an opening portion, and a composition that is accommodated inside the container and contains magnetic particles and a liquid component, in which a viscosity of the composition at a temperature of 25° C. and a shear rate of 0.1 sec⁻¹ is 1 to 1,000 Pa·s, a content of the magnetic particles having a particle diameter of 1 μm or more is 80% by volume or more with respect to a total volume of the magnetic particles, a ratio of an area of the opening portion of the container to a maximum area (hereinafter, may be abbreviated as “maximum area”) of an area surrounded by a contour line of an inner wall surface of the container in a cross section orthogonal to a height direction of the container (hereinafter, may be abbreviated as “opening portion area ratio”) is 0.8 or more and 1.0 or less, and an angle W of an inclination (hereinafter, may be abbreviated as “inclination W”) of the inner wall surface of the container with respect to the height direction of the container at a height position of half of a height H in the container at which the composition is present is 20° or less.

In the composition container according to the embodiment of the present invention having the above-described configuration, a variation in relative magnetic permeability is less likely to occur between magnetic materials obtained in a case where a composition accommodated in a container is stirred and then gradually taken out from the container and the composition is used for producing the magnetic materials each time.

In a composition containing magnetic particles and a liquid component, as the particle diameter and the specific gravity of the magnetic particles are larger, sedimentation tends to occur more easily, as is known in Stokes' law and the like. On the other hand, a method of increasing the viscosity of the composition to suppress the sedimentation of the magnetic particles is also conceivable, but there is a limit to the increase in viscosity in order to ensure manufacturing suitability such as coating properties, and there is a problem that the sedimentation of the magnetic particles is not necessarily suppressed by the above-described method. Therefore, in a case of using the composition containing magnetic particles and the liquid component, a method of increasing the viscosity of the composition during storage to suppress sedimentation by setting the storage temperature of the composition to a low temperature (refrigeration to freezing) and returning the composition to room temperature while stirring the composition before use to return the viscosity to a predetermined viscosity may be adopted. In general, in this operation, a stirring operation such as disposing a stirrer such as a stirring blade inside a container that accommodates the composition or using a stirring device such as a rotating and revolving mixer is performed.

The composition container having the above-described configuration is suitable for the stirring operation for returning the composition to the predetermined viscosity performed after the above-described low-temperature storage and the storage before use, and exhibits the above-described effects.

The presumed mechanism of action of the composition container having the above-described configuration is as follows.

In a case where the opening portion area ratio in the container of the composition container is within a predetermined numerical value range, as a stirrer such as a stirring blade disposed inside the container through the opening portion, a stirrer having a size substantially the same as the maximum area of the area surrounded by the contour line of the inner wall surface of the container in a cross section orthogonal to the height direction of the container can be used. As a result, the stirring property of the composition accommodated inside the container is improved, and a variation in relative magnetic permeability is less likely to occur between magnetic materials obtained in a case where the composition is gradually taken out from the container after stirring and the composition is used for producing the magnetic materials each time. On the other hand, in a case where the lower limit value of the opening portion area ratio is less than 0.8, the size of the stirrer such as a stirring blade disposed inside the container through the opening portion is too small as compared with the maximum area, and thus the stirring property of the composition is insufficient, and the above-described effect cannot be obtained. Note that the case where the upper limit value of the opening portion area ratio is 1.0, corresponds to a case where the area of the opening portion and the maximum area coincide with each other, that is, corresponds to the maximum value of the opening portion area ratio.

In addition, in a case where the inclination W in the container of the composition container is in a predetermined numerical value range, for example, in a case where the composition is stirred with a stirring device such as a rotating and revolving mixer, the uneven distribution of the magnetic particles in either the upperpart (or the lower part) of the container is less likely to occur, and as a result, the stirring property of the composition accommodated inside the container is improved, and a variation in relative magnetic permeability is less likely to occur between magnetic materials obtained in a case where the composition is gradually taken out from the container after stirring and the composition is used for producing the magnetic materials each time. On the other hand, in a case where the upper limit value of the inclination W is more than 20°, for example, in a case where the composition is stirred with a stirring device such as a rotating and revolving mixer, the uneven distribution of the magnetic particles occurs in either the upper part (or the lower part) of the container, and the above-described effect cannot be obtained.

In addition, the present inventor has also confirmed that in a case where the content of the magnetic particles having a particle diameter of 1 μm or more is in a predetermined numerical value range with respect to the total volume of the magnetic particles contained in the composition, the above-described effect is more excellent.

Hereinafter, a case where a variation in relative magnetic permeability is less likely to occur between magnetic materials obtained in a case where the composition accommodated in the container is stirred and then gradually taken out from the container and the composition is used for producing a magnetic material each time may be referred to as “the effect of the present invention is more excellent”.

Hereinafter, specific embodiments of the composition container according to the present invention will be described with reference to examples, and each member will be described in detail. The configuration of the composition container according to the embodiment of the present invention is not limited thereto.

### [Composition Container of First Embodiment]

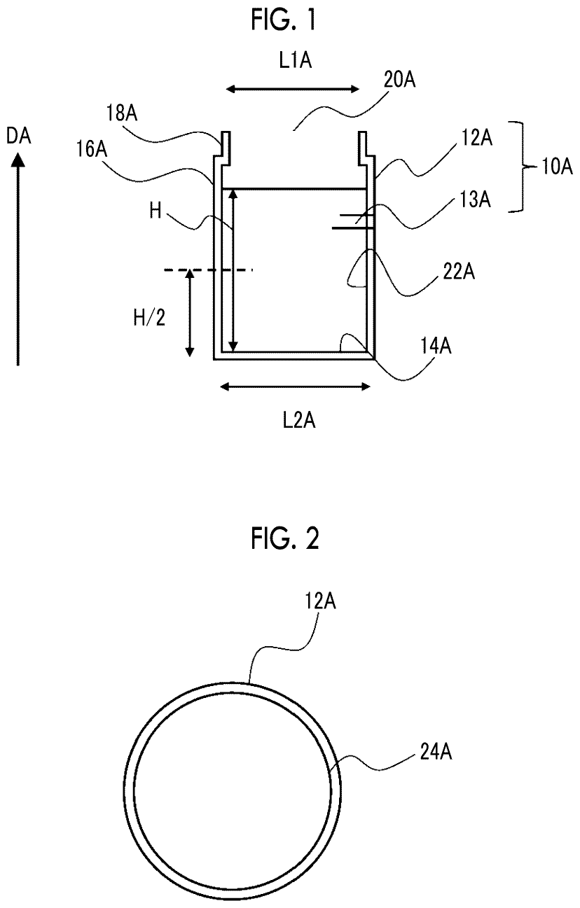

FIG. 1 is a schematic cross-sectional view showing an example of an embodiment of a composition container according to the present invention.

A composition container 10A shown in FIG. 1 has a container 12A and a composition 13A accommodated inside the container 12A. The container 12A has an opening portion 20A that serves as an inlet port in a case where a stirrer such as a stirring blade is disposed inside the container 12A, on an upper surface portion (top surface portion) facing the bottom surface 14A. That is, in the container 12A, the bottom surface 14A and the opening portion 20A are positioned to face each other. The composition container 10A may include a lid body (not shown) that is attachably and detachably attached to cover the opening portion 20A of the container 12A.

More specifically, the container 12A has a true circular bottom surface 14A, a cylindrical body portion 16A that rises from an edge portion of the bottom surface 14A in parallel with the height direction of the container 12A (hereinafter, may be abbreviated as a “height direction DA”), an extending portion that extends from one end of the body portion 16A on a side opposite to the bottom surface 14A side toward the inside of the body portion 16A, and a cylindrical mouth-neck portion 18A that rises from an edge portion of the extending portion on a side opposite to the body portion 16A side in parallel with the height direction DA of the container 12A, and a true circular opening portion 20A is provided at a distal end portion of the mouth-neck portion 18A. A diameter of the opening portion 20A is L1A, and a diameter of the bottom surface 14A is L2A. Note that the inner wall surface 22A of the container 12A (each inner wall surface of the body portion 16A and the mouth-neck portion 18A) is configured to be perpendicular to the bottom surface 14A. In addition, the bottom surface 14A and the plane including the distal end portion of the mouth-neck portion 18A are parallel to each other.

In the container 12A, a ratio of the area of the opening portion 20A of the container 12A (opening area ratio) to the maximum area of the area surrounded by the contour line of the inner wall surface 22A of the container 12A in a cross section orthogonal to the height direction DA of the container 12A is 0.8 or more and 1.0 or less. Here, the area surrounded by the contour line of the inner wall surface 22A of the container 12A in the cross section orthogonal to the height direction DA of the container 12A means, for example, a circular region surrounded by the contour line 24A corresponding to the inner wall surface 22A in a case where the cross-sectional view of the container 12A in the cross section at a height position of half of the height H of the container 12A in which the composition 13A is present (in other words, a height position of H/2 from the bottom surface 14A) is shown as an example in FIG. 2. The maximum area means the largest area of the area surrounded by the contour line of the inner wall surface 22A of the container 12A in the orthogonal cross section at different height positions of the container 12A. In the container 12A, since the body portion 16A is provided in the vertical direction from the edge portion of the bottom surface 14A, the maximum area is the same as the area of the bottom surface 14A and corresponds to the area of a circle having a diameter L2A, and the area of the opening portion 20A corresponds to the area of a circle having a diameter L1A.

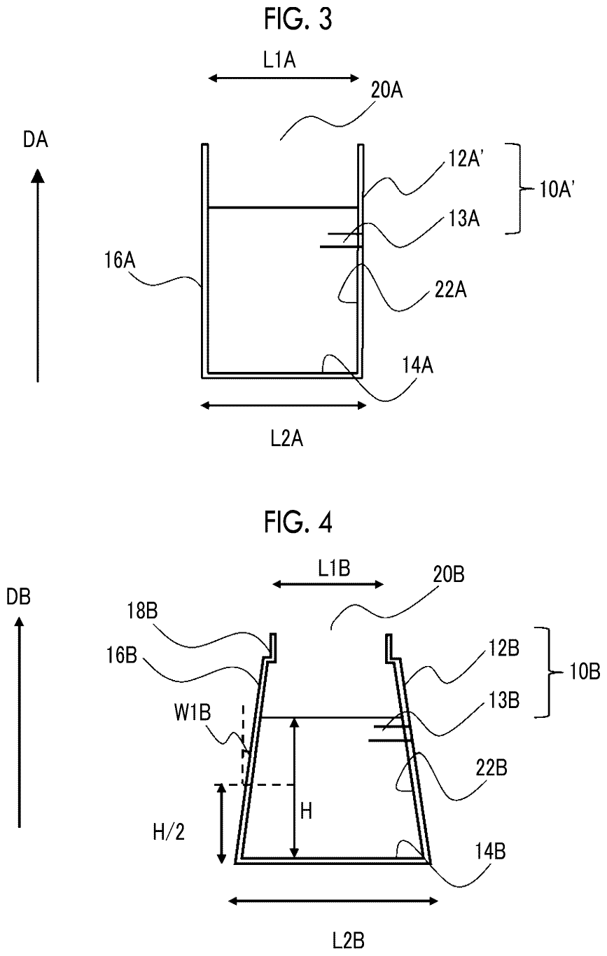

In addition, the container 12A may have a shape in which, for example, the mouth-neck portion is not provided and the top surface portion of the body portion 16A is the opening portion 20A (see FIG. 3).

A composition container 10A′ shown in FIG. 3 has a container 12A′ and a composition 13A accommodated inside the container 12A′. The container 12A′ has a true circular bottom surface 14A and a cylindrical body portion 16A that rises from an edge portion of the bottom surface 14A in a height direction of the container, and an opening portion 20A is provided on a side of the body portion 16A opposite to the bottom surface 14A side. The composition container 10A′ in FIG. 3 has the same configuration as the composition container 10A shown in FIG. 1 except that the container 12A′ does not have a mouth-neck portion and the top surface portion of the body portion 16A is the opening portion 20A. In the composition container 10A′, the area of the opening portion 20A (the area of the circle having the diameter L1A) and the maximum area of the area surrounded by the contour line of the inner wall surface 22A of the container 12A′ in the cross section orthogonal to the height direction DA of the container 12A′ coincide with each other, so that the opening area ratio is 1.0.

In a case where the opening area ratio is within the predetermined numerical value range described above, a stirrer such as a stirring blade disposed inside the container 12A through the opening portion 20A can be used as a stirrer having a size substantially the same as the maximum area. As a result, the stirring property of the composition 13A accommodated inside the container 12A is improved, and a variation in relative magnetic permeability is less likely to occur between magnetic materials obtained in a case where the composition 13A is gradually taken out from the container 12A after stirring and the composition 13A is used for producing the magnetic materials each time.

Further, the angle W1A (not shown) of the inclination of the inner wall surface 22A of the container 12A with respect to the height direction DA of the container 12A at a height position of half of the height H in the container 12A at which the composition 13A is present (in other words, a height position of H/2 from the bottom surface 14A) is 0°. In other words, the angle W1A of the inclination of the inner wall surface 22A of the container 12A with respect to the height direction DA of the container 12A at the height position of half of the height H in the container 12A at which the composition 13A is present (the height position of H/2 from the bottom surface 14A) is 0°. Here, the height H in the container 12A at which the composition 13A is present means a height from a bottom surface 14A of the composition 13A present in the container 12A before the composition in the composition container 10A is stirred.

The angle W1A can be measured, for example, by the following method. The tangent line of the inner wall surface 22A is obtained at a height position of H/2 from the bottom surface 14A on the inner wall surface 22A by cutting the container 12A in a direction along the height direction DA of the container 12A to expose the inner wall surface 22A of the container 12A, and the angle of the inclination between the tangent line and the height direction DA of the container 12A is obtained.

Note that in the container 12A, the angle W1A of the inclination of the inner wall surface 22A at the height position of H/2 from the bottom surface 14A with respect to the height direction DA of the container 12A is 0° at any position in the circumferential direction of the body portion 16A.

In a case where the angle W1A is 0° in the container 12A of the composition container 10A, for example, in a case where the composition 13A in the composition container 10A is stirred with a stirring device such as a rotating and revolving mixer, it is considered that the composition 13A in the container 12A is more uniformly subjected to the centrifugal separation process, and the uneven distribution of the magnetic particles in either the upper part (or the lower part) of the container 12A is less likely to occur. As a result, the stirring property of the composition 13A accommodated inside the container 12A is improved, and a variation in relative magnetic permeability is less likely to occur between magnetic materials obtained in a case where the composition 13A is gradually taken out from the container 12A after stirring and the composition 13A is used for producing the magnetic materials each time.

In the container 12A, the shape of the bottom surface 14A is a true circle, but the present invention is not limited to this form. The shape of the bottom surface 14A may be elliptical or rectangular.

In the container 12A, the shape of the opening portion 20A is a true circle, but the present invention is not limited to this form. The shape of the opening portion 20A may be elliptical or rectangular.

### [Composition Container of Second Embodiment]

FIG. 4 is a schematic cross-sectional view showing an example of an embodiment of the composition container according to the present invention.

A composition container 10B shown in FIG. 4 has a container 12B and a composition 13B accommodated in the container 12B. The container 12B has an opening portion 20B that serves as an inlet port in a case where a stirrer such as a stirring blade is disposed inside the container 12B, on an upper surface portion (top surface portion) facing the bottom surface 14B. That is, in the container 12B, the bottom surface 14B and the opening portion 20B are positioned to face each other. The composition container 10B may include a lid body (not shown) that is attachably and detachably attached to cover the opening portion 20B of the container 12B.

More specifically, the container 12B has a true circular bottom surface 14B, a body portion 16B that rises from an edge portion of the bottom surface 14B in a height direction of the container 12B (hereinafter, may be abbreviated as a “height direction DB”), an extending portion that extends from one end of the body portion 16B on a side opposite to the bottom surface 14B side toward the inside of the body portion 16B, and a cylindrical mouth-neck portion 18B that rises from an edge portion of the extending portion on a side opposite to the body portion 16B side in parallel with the height direction DB of the container 12B, and a true circular opening portion 20B is provided at a distal end portion of the mouth-neck portion 18B. A diameter of the opening portion 20B is L1B, and a diameter of the bottom surface 14B is L2B. In the body portion 16B, a cross-sectional area in a cross section orthogonal to the height direction DB of the container 12B gradually decreases from the bottom surface 14B toward the opening portion 20B. That is, in the container 12B, the bottom surface 14B and the body portion 16B constitute a truncated cone. In addition, the inner wall surface 22B of the mouth-neck portion 18B of the inner wall surface 22B of the container 12B (each inner wall surface of the body portion 16B and the mouth-neck portion 18B) is configured to be perpendicular to the bottom surface 14B. In addition, the bottom surface 14B and the plane including the distal end portion of the mouth-neck portion 18B are parallel to each other.

In the container 12B, a ratio of the area of the opening portion 20B of the container 12B (opening area ratio) to the maximum area of the area surrounded by the contour line of the inner wall surface 22B of the container 12B in a cross section orthogonal to the height direction DB of the container 12B is 0.8 or more and 1.0 or less. In the container 12B, as described above, the cross-sectional area of the body portion 16B in a cross section orthogonal to the height direction DB of the container 12B gradually decreases from the bottom surface 14B toward the opening portion 20B. Therefore, the maximum area corresponds to the area of a circle (the area of a circle having a diameter L2B) that coincides with the area of the bottom surface 14B. In addition, the area of the opening portion 20B corresponds to the area of a circle having a diameter L1B.

In addition, the container 12B may have a shape in which, for example, the mouth-neck portion is not provided and the top surface portion of the body portion 16B is the opening portion 20B.

The reason why the opening area ratio is preferably within the predetermined numerical value range described above is the same as the reason described in the first embodiment.

Further, the angle W1B of the inclination of the inner wall surface 22B of the container 12B with respect to the height direction DB of the container 12B at a height position of half of the height H in the container 12B at which the composition 13B is present (in other words, a height position of H/2 from the bottom surface 14B) is 20° or less. In other words, the angle W1B of the inclination of the inner wall surface 22B of the container 12B with respect to the height direction DB of the container 12B at the height position of half of the height H in the container 12B at which the composition 13B is present (the height position of H/2 from the bottom surface 14B) is 20° or less.

Here, the height H in the container 12B at which the composition 13B is present means a height from a bottom surface 14B of the composition 13B present in the container 12B before the composition of the composition container 10B is stirred.

The angle W1B can be measured, for example, by the following method. The tangent line of the inner wall surface 22B is obtained at a height position of H/2 from the bottom surface 14B on the inner wall surface 22B by cutting the container 12B in a direction along the height direction DB of the container 12B to expose the inner wall surface 22B of the container 12B, and the angle of the inclination between the tangent line and the height direction DB of the container 12B is obtained.

Note that in the container 12B, the angle W1B of the inclination of the inner wall surface 22B at the height position of H/2 from the bottom surface 14B with respect to the height direction DB of the container 12B is 20° or less at any position in the circumferential direction of the body portion 16B.

In a case where the angle W1B is 20° or less in the container 12B of the composition container 10B, for example, in a case where the composition 13B in the composition container 10B is stirred with a stirring device such as a rotating and revolving mixer, it is considered that the composition 13B in the container 12B is more uniformly subjected to the centrifugal separation process, and the uneven distribution of the magnetic particles in either the upper part (or the lower part) of the container 12B is less likely to occur. As a result, the stirring property of the composition 13B accommodated inside the container 12B is improved, and a variation in relative magnetic permeability is less likely to occur between magnetic materials obtained in a case where the composition 13B is gradually taken out from the container 12B after stirring and the composition 13B is used for producing the magnetic materials each time.

In the container 12B, the shape of the bottom surface 14B is a true circle, but the present invention is not limited to this form. The shape of the bottom surface 14B may be elliptical or rectangular.

In the container 12B, the shape of the opening portion 20B is a true circle, but the present invention is not limited to this form. The shape of the opening portion 20B may be elliptical or rectangular.

### [Composition Container of Third Embodiment]

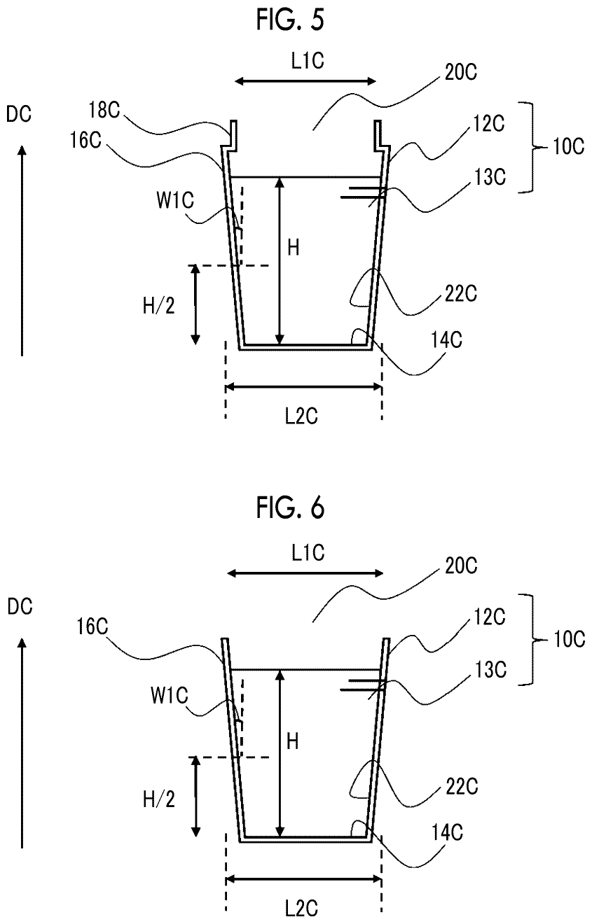

FIG. 5 is a schematic cross-sectional view showing an example of an embodiment of the composition container according to the present invention.

A composition container 10C shown in FIG. 5 has a container 12C and a composition 13C accommodated inside the container 12C. The container 12C has an opening portion 20C that serves as an inlet port in a case where a stirrer such as a stirring blade is disposed inside the container 12C, on an upper surface portion (top surface portion) facing the bottom surface 14C. That is, in the container 12C, the bottom surface 14C and the opening portion 20C are positioned to face each other. The composition container 10C may include a lid body (not shown) that is attachably and detachably attached to cover the opening portion 20C of the container 12C.

More specifically, the container 12C has a true circular bottom surface 14C, a body portion 16C that rises from an edge portion of the bottom surface 14C in a height direction of the container 12C (hereinafter, may be abbreviated as a “height direction DC”), an extending portion that extends from one end of the body portion 16C on a side opposite to the bottom surface 14C side toward the inside of the body portion 16C, and a cylindrical mouth-neck portion 18C that rises from an edge portion of the extending portion on a side opposite to the body portion 16C side in parallel with the height direction DC of the container 12C, and a true circular opening portion 20C is provided at a distal end portion of the mouth-neck portion 18C. A diameter of the opening portion 20B is L1C. In the body portion 16C, a cross-sectional area in a cross section orthogonal to the height direction DC of the container 12C gradually increases from the bottom surface 14C toward the opening portion 20C. That is, in the container 12C, the bottom surface 14C and the body portion 16C constitute a reverse truncated cone. In addition, the inner wall surface 22C of the mouth-neck portion 18C of the inner wall surface 22C of the container 12C (each inner wall surface of the body portion 16C and the mouth-neck portion 18C) is configured to be perpendicular to the bottom surface 14C. In addition, the bottom surface 14C and the plane including the distal end portion of the mouth-neck portion 18C are parallel to each other.

In the container 12C, a ratio of the area of the opening portion 20C of the container 12C (opening area ratio) to the maximum area of the area surrounded by the contour line of the inner wall surface 22C of the container 12C in a cross section orthogonal to the height direction DC of the container 12C is 0.8 or more and 1.0 or less. In the container 12C, as described above, the cross-sectional area of the body portion 16C in a cross section orthogonal to the height direction DC of the container 12C gradually increases from the bottom surface 14C toward the opening portion 20C. Therefore, the maximum area corresponds to a cross section at a height position farthest from the bottom surface 14C of the body portion 16C and an area of a circle having a diameter L2C at the height position farthest from the bottom surface 14C of the body portion 16C. In addition, the area of the opening portion 20C corresponds to the area of a circle having a diameter L1C.

In addition, the container 12C may have a shape in which, for example, the mouth-neck portion is not provided and the top surface portion of the body portion 16C is the opening portion 20C (see FIG. 6).

The reason why the opening area ratio is preferably within the predetermined numerical value range described above is the same as the reason described in the first embodiment.

Further, the angle W1C of the inclination of the inner wall surface 22C of the container 12C with respect to the height direction DC of the container 12C at a height position of half of the height H in the container 12C at which the composition 13C is present (in other words, a height position of H/2 from the bottom surface 14C) is 20° or less. In other words, the angle W1C of the inclination of the inner wall surface 22C of the container 12C with respect to the height direction DC of the container 12C at a height position of half of the height H in the container 12C at which the composition 13C is present (in other words, a height position of H/2 from the bottom surface 14C) is 20° or less.

Here, the height H in the container 12C at which the composition 13C is present means a height from a bottom surface 14C of the composition 13C present in the container 12C before the composition 13C in the composition container 10C is stirred.

The angle W1C can be measured, for example, by the following method. The tangent line of the inner wall surface 22C is obtained at a height position of H/2 from the bottom surface 14C on the inner wall surface 22C by cutting the container 12C in a direction along the height direction DC of the container 12C to expose the inner wall surface 22C of the container 12C, and the angle of the inclination between the tangent line and the height direction DC of the container 12C is obtained.

Note that in the container 12C, the angle W1C of the inclination of the inner wall surface 22C at the height position of H/2 from the bottom surface 14C with respect to the height direction DC of the container 12C is 20° or less at any position in the circumferential direction of the body portion 16C.

The reason why the angle W1C in the container 12C of the composition container 10C is preferably 20° or less is the same as the reason why the angle W1B described in the second embodiment is preferably 20° or less.

In the container 12C, the shape of the bottom surface 14C is a true circle, but the present invention is not limited to this form. The shape of the bottom surface 14C may be elliptical or rectangular.

In the container 12C, the shape of the opening portion 20C is a true circle, but the present invention is not limited to this form. The shape of the opening portion 20C may be elliptical or rectangular.

### [Suitable Aspects of Composition Container of First to Third Embodiments]

The composition container of the first to third embodiments described above preferably further has the following aspects.

In the composition container, in a volume-based cumulative particle size distribution of the magnetic particles contained in the composition, in a case where particle diameters of the magnetic particles corresponding to a cumulative percentage of 10% and 90% are respectively denoted by D10 and D90, it is preferable that D90/D10≥3.7, and a relationship between the inclination W (°), D10, and D90 satisfies Formula (C1).

cos(90−W)°×(D90/D10)²≤5.00 Formula (C1):

In Formula (C1), the lower limit value of the numerical value represented by cos(90−W)°×(D90/D10)² is, for example, 0.0 or more.

In Formula (C1), the inclination W (°) corresponds to the inclination W1A (°) in the composition container 10A, the inclination W1B (°) in the composition container 10B, and the inclination W1C (°) in the composition container 10C.

The rotating and revolving mixer is accompanied by an action in which particles move outward due to a centrifugal force, and in this case, it can be assumed that the movement of the particles due to the centrifugal force moves in proportion to the square of the particle diameter according to Stokes' law. The present inventors have conducted studies focusing on a relationship between a difference in ease of movement of particles having a large particle diameter and particles having a small particle diameter and a difference in centrifugal force due to a rotation radius in stirring, and have found that, in a case where the composition container satisfies the above-described conditions, the stirring suitability is significantly improved in a case of stirring with a rotating and revolving mixer.

In addition, in the composition container, from the viewpoint that the effect of the present invention is more excellent, the inner volume of the container is, for example, preferably 18 L or less, more preferably 10 L or less, still more preferably 2.8 L or less, and particularly preferably 1 L or less. The lower limit value is, for example, preferably 0.05 L or more.

In addition, in the composition container, from the viewpoint that the effect of the present invention is more excellent and/or the fluidity of the composition is more excellent and the coating properties are improved, the void ratio (% by volume) calculated by Formula (C2) is preferably 75% by volume or less.

Void ratio=(a volume of a void portion obtained by subtracting a volume occupied by the composition from the inner volume of the container/the inner volume of the container)×100 Formula (C2):

Among these, the void ratio is more preferably 50% by volume or less and still more preferably 25% by volume or less. The lower limit value is, for example, preferably 1% by volume or more.

In the composition container, in a case where the void ratio is relatively large, the viscosity of the composition may decrease due to the volatilization of the organic solvent that may be contained in the composition, which may affect the coating suitability. Therefore, in a case where the void ratio is relatively large, it is preferable to increase the content of the organic solvent in the composition, and for example, it is desirable to set the content of the organic solvent to 6.0% by mass or more with respect to the total mass of the composition.

In addition, the atmosphere gas in the void portion is not particularly limited, and may be, for example, air or an inert gas.

From the viewpoint of further improving the storage stability of the composition in the container, the composition of the atmosphere gas in the void portion is preferably an oxygen partial pressure of 204 hPa or less. Among these, the oxygen partial pressure is more preferably 102 hPa or less and still more preferably 10 hPa or less. The lower limit value is, for example, preferably 1 Pa or more.

In addition, in the composition container, the area of the opening portion of the container is preferably 10 to 500 cm², more preferably 20 to 350 cm², and still more preferably 30 to 150 cm².

In addition, in the composition container, the height of the body portion of the container is preferably 1 to 50 cm, more preferably 2 to 40 cm, and still more preferably 3 to 30 cm.

In addition, in the composition container, it is preferable that a minimum area of an area surrounded by a contour line of an inner wall surface of the container in a cross section orthogonal to a height direction of the container is equal to or larger than an area of the opening portion.

In addition, in the composition container, the shape of the bottom surface and the opening portion is preferably a true circle, an ellipse, or a rectangle.

In particular, in a case where, as the shape of the opening portion, a distance between parallel planes selected from parallel planes circumscribing the opening portion such that a distance between the parallel planes is longest is set as a major axis, and a distance between parallel planes selected from parallel planes that are orthogonal to the parallel planes to which the major axis is given and circumscribe the opening portion such that a distance between the parallel planes is shortest is set as a minor axis, a ratio of a length of the major axis to a length of the minor axis is preferably 1.0 to 1.2, and more preferably 1.0 to 1.1.

In addition, in a case where, as the shape of the bottom surface, a distance between the parallel planes selected from parallel planes circumscribing the bottom surface such that a distance between the parallel planes is longest is set as a major axis, and a distance between the parallel planes selected from parallel planes that are orthogonal to the parallel planes to which the major axis is given and circumscribe the bottom surface such that a distance between the parallel planes is shortest is set as a minor axis, a ratio of the length of the major axis to the length of the minor axis is preferably 1.0 to 1.2, and more preferably 1.0 to 1.1.

In addition, in the composition container, the shape of the body portion and the mouth-neck portion of the container is not particularly limited, and examples thereof include a cylindrical shape, an elliptical cylindrical shape, and a rectangular tubular shape, where a cylindrical shape or an elliptical cylindrical shape is preferable, and a cylindrical shape is more preferable.

In addition, in the composition container, the container may have a gas inlet port for introducing a gas therein, or may have a gas outlet port for discharging the gas therein to the outside of the container.

In addition, in the composition container, the container may include a lid body that is attachably and detachably attached to cover an opening portion of the container. The lid body may further have an opening portion through which a stirring shaft of a stirrer introduced for stirring the composition accommodated in the container of the composition container passes.

It is preferable that the stirrer introduced for stirring the composition accommodated in the container of the composition container includes a rotatable stirring shaft and a plurality of stirring blades attached to the stirring shaft.

It is preferable that the stirring shaft extends from the outside to the inside of the container and is rotatably attached to the outside of the container with a driving source (for example, a motor or the like). The stirring blade is moved along the circumferential direction of the stirring shaft by rotating the stirring shaft by the driving source, and the composition in the container is stirred.

The type of the stirring blade is not particularly limited, and examples thereof include a propeller type, a dissolver type, an anchor type, a helical ribbon type, and an inclined paddle type.

In the composition container, the material of the container is not particularly limited, and examples thereof include glass and resin.

Specific examples of the resin include polytetrafluoroethylene (PTFE), polyethylene (PE), and polypropylene (PP).

In addition, the thickness of the wall of the container is not particularly limited, and is preferably 0.1 to 10 mm, more preferably 0.2 to 7 mm, and still more preferably 0.3 to 5 mm.

In addition, the inclination W (°) (for example, the inclination W1A (°) in the composition container 10A, the inclination W1B (°) in the composition container 3, and the inclination W1C (°) in the composition container 4) is preferably 0° to 20°, more preferably 0° to 10°, and still more preferably 0° to 5°.

The rotating and revolving mixer used for stirring the composition accommodated in the container of the composition container is not particularly limited, and a known mixer can be used.

### [Composition]

Hereinafter, the composition accommodated inside the container in the composition container will be described.

The composition contains magnetic particles and a liquid component, and has a viscosity of 1 to 1,000 Pa·s measured under conditions of a temperature of 25° C. and a shear rate of 0.1 sec⁻¹.

Here, the “liquid component” means that a single body state of the component is a liquid at an atmospheric pressure (1 atm) at a temperature of 25° C. The liquid component is a component that satisfies the above-described physical properties, and specifically, components such as an organic solvent and a liquid binder component correspond to the liquid component.

In addition, the viscosity of the composition measured under the conditions of a temperature of 25° C. and a shear rate of 0.1 sec⁻¹ is preferably 1 to 800 Pa·s, more preferably 1 to 500 Pa·s, still more preferably 1 to 300 Pa·s, and particularly preferably 1 to 2000 Pa·s.

The viscosity of the composition can be measured using, for example, MCR-102 (manufactured by Anton Paar GmbH).

Hereinafter, various components contained in the composition will be described.

### <Magnetic Particles>

The composition contains magnetic particles.

The magnetic particles usually contain a metal atom.

In the present specification, examples of the above-described metal atom also include metalloid atoms such as boron, silicon, germanium, arsenic, antimony, and tellurium.

The magnetic particles may contain the above-described metal atom as an alloy including a metal element, a metal oxide, a metal nitride, or a metal carbide.

The above-described metal atom is not particularly limited, but preferably includes at least one metal atom selected from the group consisting of Fe, Ni, and Co.

A content of the at least one metal atom selected from the group consisting of Fe, Ni, and Co (in the case where a plurality of types of metal atoms are contained, the total content thereof) is preferably 50% by mass or more, more preferably 60% by mass or more, and still more preferably 70% by mass or more with respect to the total mass of metal atoms in the magnetic particles. The upper limit value of the above-described content is not particularly limited, but for example, it is 100% by mass or less, preferably 98% by mass or less and more preferably 95% by mass or less.

The magnetic particles may contain a material other than Fe, Ni, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, N, and O.

In a case where the magnetic particles contain a metal atom other than Fe, Ni, and Co, it is preferable that the magnetic particles further contain one or more selected from the group consisting of Si, Cr, B, and Mo.

A shape of the magnetic particles is not particularly limited and may be any of a plate shape, an elliptical shape, a spherical shape, or an amorphous shape, but from the viewpoint that the effect of the present invention is more excellent, a spherical shape is preferable.

As the magnetic particles, alloy particles are preferable.

From the viewpoint that the effect of the present invention is more excellent, the alloy particles preferably contain Fe.

Examples of the metal atom other than Fe in the alloy particles include Ni and Co.

In a case where the alloy particles contain Fe, a content of Fe is preferably 50% by mass or more, more preferably 60% by mass or more, and still more preferably 70% by mass or more with respect to the content of metal atoms in the alloy particles. The upper limit value of the above-described content is not particularly limited, but for example, it is 100% by mass or less, preferably 98% by mass or less and more preferably 95% by mass or less.

A volume-average particle diameter of the alloy particles is not particularly limited and usually 1 to 60 μm, and from the viewpoint that the effect of the present invention is more excellent, it is preferably 1 to 30 μm and more preferably 1 to 20 μm.

The volume-average particle diameter of the alloy particles is a so-called median diameter (D50), and can be obtained based on a particle size distribution curve representing a volume-based frequency distribution of the alloy particles, which is obtained by a laser diffraction scattering-type particle size distribution analyzer (for example, product “LA960N” manufactured by HORIBA, Ltd).

Examples of the alloy particles include Fe—Co-based alloy particles (preferably, Permendur), Fe—Ni-based alloy particles (for example, Permalloy), Fe—Zr-based alloy particles, Fe—Mn-based alloy particles, Fe—Si-based alloy particles, Fe—Al-based alloy particles, Ni—Mo-based alloy particles (preferably, Supermalloy), Fe—Ni—Co-based alloy particles, Fe—Si—Cr-based alloy particles, Fe—Si—B-based alloy particles, Fe—Si—Al-based alloy particles (preferably, Sendust), Fe—Si—B—C-based alloy particles, Fe—Si—B—Cr-based alloy particles, Fe—Si—B—Cr—C-based alloy particles, Fe—Co—Si—B-based alloy particles, Fe—Si—B—Nb-based alloy particles, Fe nanocrystalline alloy particles, Fe-based amorphous alloy particles, and Co-based amorphous alloy particles. The above-described alloy may be amorphous.

As the magnetic particles, ferrite particles are also preferable.

In addition to Fe constituting the iron oxide, the ferrite particles preferably contain at least one metal atom selected from the group consisting of Ni, Mn, and Co, and from the viewpoint that the effect of the present invention is more excellent, it is more preferable that the ferrite particles contain an Ni atom.

In addition, the ferrite particles may contain a material other than Ni, Mn, Fe, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Cr, Nb, Pb, Ca, B, C, N, and O.

A volume-average particle diameter of the ferrite particles is not particularly limited and usually 1 to 60 μm, and from the viewpoint that the effect of the present invention is more excellent, it is preferably 5 to 55 μm and more preferably 10 to 50 μm.

The volume-average particle diameter of the ferrite particles is a so-called median diameter (D50), and can be obtained based on a particle size distribution curve representing a volume-based frequency distribution of the ferrite particles, which is obtained by a laser diffraction scattering-type particle size distribution analyzer (for example, product “LA960N” manufactured by HORIBA, Ltd).

Examples of the ferrite particles include Ni ferrite, Mn ferrite, and spinel ferrite (preferably, Ni—Zn-based ferrite, Mn—Zn-based ferrite, or Fe—Mn-based ferrite).

A surface layer may be provided on at least a part of a surface of the magnetic particles. Since the magnetic particles have the surface layer, a function according to a material of the surface layer can be imparted to the magnetic particles.

Examples of the surface layer include an inorganic layer and an organic layer, and an organic layer is preferable.

From the viewpoint that it is possible to form a surface layer excellent in at least one of insulation properties, gas barrier properties, or chemical stability, a compound for forming the inorganic layer is preferably a metal oxide, a metal nitride, a metal carbide, a metal phosphate compound, a metal borate compound, or a silicate compound (for example, a silicate ester such as tetraethyl orthosilicate or a silicate such as sodium silicate). Specific examples of elements contained in these compounds include Fe, Al, Ca, Mn, Zn, Mg, V, Cr, Y, Ba, Sr, Ge, Zr, Ti, Si, and rare earth elements.

Examples of a material constituting the inorganic layer obtained from the compound for forming an inorganic layer include silicon oxide, germanium oxide, titanium oxide, aluminum oxide, zirconium oxide, and magnesium oxide, and the inorganic layer may be a layer containing two or more kinds thereof.

Examples of a compound for forming the organic layer include an acrylic monomer. Specific examples of the acrylic monomer include compounds described in paragraphs 0022 to 0023 of JP2019-067960A.

Examples of a material constituting the organic layer obtained from the compound for forming an organic layer include an acrylic resin.

A thickness of the surface layer is not particularly limited, but from the viewpoint that the function of the surface layer is further exhibited, it is preferably 3 to 1,000 nm.

The magnetic particles may be used alone or in combination of two or more kinds thereof.

In a case where two or more kinds of magnetic particles are used in combination, a combination of the ferrite particles and the alloy particles or a combination of the alloy particles and the alloy particles is preferable, and a combination of the ferrite particles and the alloy particles is more preferable.

In addition, in a case where the ferrite particles and the alloy particles are used in combination as the magnetic particles, a content ratio (mass ratio: ferrite particles/alloy particles) is preferably 30/70 to 70/30 and more preferably 40/60 to 60/40.

In addition, in a case where the alloy particles (first alloy particles) and the alloy particles (second alloy particles) are used in combination as the magnetic particles, a content ratio (mass ratio: first alloy particles/second alloy particles) is preferably 30/70 to 70/30, and more preferably 40/60 to 60/40.

A content of the magnetic particles (in a case where a plurality of types of magnetic particles are contained, the total content thereof) in the composition is preferably 70% by mass or more, more preferably 75% by mass or more, still more preferably 80% by mass or more, and particularly preferably 90% by mass or more with respect to the total mass of the composition. In addition, the upper limit value thereof is preferably 95% by mass or less, and more preferably 90% by mass or less.

The content of the magnetic particles (in a case where a plurality of types of magnetic particles are contained, the total content thereof) in the composition is preferably 70% by mass or more, more preferably 75% by mass or more, still more preferably 80% by mass or more, particularly preferably 90% by mass or more, and most preferably 92% by mass or more with respect to the total solid content of the composition. In addition, the upper limit value thereof is preferably 97% by mass or less, and more preferably 95% by mass or less.

In addition, in the composition, the content of the magnetic particles having a particle diameter of 1 μm or more is preferably 80% by volume or more, more preferably 90% by volume or more, still more preferably 95% by volume or more, particularly preferably 98% by volume or more, and most preferably 99% by volume or more with respect to the total volume of the magnetic particles. Note that the upper limit value of the content of the magnetic particles having a particle diameter of 1 μm or more in the composition is not particularly limited, and is preferably 100% by volume or less with respect to the content of the magnetic particles.

The content of the magnetic particles having a particle diameter of 1 μm or more is determined by the following procedure.

First, using a scanning electron microscope (SEM; for example, “S-4800H” manufactured by Hitachi High-Tech Corporation or the like can be used), the magnetic particles are observed, and 1,000 magnetic particles are randomly selected and imaged in any observation visual field.

Next, the obtained image information is introduced into an image analysis apparatus (for example, image analysis software “Image-Pro PLUS” manufactured by Media Cybernetics, Inc.) through an interface to perform the analysis, thereby obtaining a projection area of each particle. The projection area is intended to be a projection area of primary particles.

In addition, for each particle, an equivalent circle diameter is calculated from the projection area of the magnetic particles obtained by the above-described procedure. The equivalent circle diameter is a diameter of a true circle in a case where a true circle having the same projection area as the projection area of the magnetic particles during the observation is assumed. Next, a volume of each of the 1,000 magnetic particles which are the above-described measurement target is calculated by Numerical Formula (1).

Volume=(Equivalent circle diameter of magnetic particles)³×(π/6) Numerical Formula (1):

Next, from the above-described measurement results, “total volume of magnetic particles having a particle diameter (equivalent circle diameter) of 1 μm or more” and “total volume of 1,000 magnetic particles” are obtained, and a volume fraction (% by volume) of the “total volume of magnetic particles having a particle diameter (equivalent circle diameter) of 1 μm or more” with respect to the “total volume of 1,000 magnetic particles” is calculated.

The above-described measurements may be performed by obtaining powder of the magnetic particles from the composition containing the magnetic particles and an organic solvent by any method (baking, sedimentation, or the like), or may be performed on a film formed of the composition containing the magnetic particles and an organic solvent. In particular, the above-described measurements are preferably carried out on the film formed of the composition. The above-described film may be a coating film or a cured film.

In addition, in the magnetic particles contained in the composition, in a volume-based cumulative particle size distribution of the magnetic particles, it is preferable that D90/D10≥3.7 is satisfied in a case where particle diameters of the magnetic particles corresponding to cumulative percentages of 10% and 90% are respectively denoted by D10 and D90.

From the viewpoint that the effect of the present invention is more excellent, the value represented by D90/D10 is more preferably 3.7 or more and still more preferably 10 or more. Note that the upper limit value is preferably 100 or less and more preferably 75 or less.

The volume-based cumulative particle size distribution of the magnetic particles can be obtained by a laser diffraction scattering-type particle size distribution analyzer (for example, “LA960N” manufactured by HORIBA, Ltd.).

### <Organic Solvent>

The composition preferably contains an organic solvent.

A type of the organic solvent is not particularly limited, and examples thereof include an ester-based solvent (preferably, an acetate-based solvent), a ketone-based solvent, an alcohol-based solvent, an amide-based solvent, an ether-based solvent, and a hydrocarbon-based solvent.

The organic solvent may be used alone, or in combination of two or more kinds thereof.

A lower limit value of a boiling point of the organic solvent is preferably 55° C. or higher, and from the viewpoint that the effect of the present invention is more excellent, it is more preferably 80° C. or higher and still more preferably 100° C. or higher. An upper limit value of the boiling point of the organic solvent is not particularly limited, but is preferably 400° C. or lower.

Examples of the organic solvent include acetone (boiling point: 56° C.), methyl ethyl ketone (boiling point: 79.6° C.), ethanol (boiling point: 78.4° C.), cyclohexane (boiling point: 80.8° C.), ethyl acetate (boiling point: 77.1° C.), ethylene dichloride (boiling point: 83.5° C.), tetrahydrofuran (boiling point: 66° C.), cyclohexanone (boiling point: 155.6° C.), toluene (boiling point: 110° C.), ethylene glycol monomethyl ether (boiling point: 124° C.), ethylene glycol monoethyl ether (boiling point: 135° C.), ethylene glycol dimethyl ether (boiling point: 84° C.), propylene glycol monomethyl ether (boiling point: 120° C.), propylene glycol monoethyl ether (boiling point: 132° C.), acetylacetone (boiling point: 140° C.), cyclopentanone (boiling point: 131° C.), ethylene glycol monomethyl ether acetate (boiling point: 144.5° C.), ethylene glycol ethyl ether acetate (boiling point: 145° C.), ethylene glycol monoisopropyl ether (boiling point: 141° C.), diacetone alcohol (boiling point: 166° C.), ethylene glycol monobutyl ether acetate (boiling point: 192° C.), 1,4-butanediol diacetate (“1,4-BDDA”, boiling point: 232° C.), 1,6-hexanediol diacetate (“1,6-HDDA”, boiling point: 260° C.), 1,3-butylene glycol diacetate (“1,3-BGDA”, boiling point: 232° C.), propylene glycol diacetate (“PGDA”, boiling point: 190° C.), glycerol triacetate (boiling point: 260° C.), 3-methoxy-1-propanol (boiling point: 150° C.), 3-methoxy-1-butanol (boiling point: 161° C.), diethylene glycol monomethyl ether (boiling point: 194° C.), diethylene glycol monoethyl ether (boiling point: 202° C.), diethylene glycol dimethyl ether (boiling point: 162° C.), diethylene glycol diethyl ether (boiling point: 188° C.), propylene glycol monomethyl ether acetate (“PGMEA”, boiling point: 146° C.), propylene glycol monoethyl ether acetate (boiling point: 146° C.), N,N-dimethylformamide (boiling point: 153° C.), dimethyl sulfoxide (boiling point: 189° C.), 7-butyrolactone (boiling point: 204° C.), butyl acetate (boiling point: 126° C.), methyl lactate (boiling point: 144° C.), N-methyl-2-pyrrolidone (boiling point: 202° C.), and ethyl lactate (boiling point: 154° C.).

In a case where the composition contains an organic solvent, the content of the organic solvent is preferably 0.1% by mass or more, more preferably 1.0% by mass or more, still more preferably 3.0% by mass or more, and particularly preferably 6.0% by mass or more with respect to the total mass of the composition. Note that the upper limit value thereof is preferably 12.0% by mass or less, more preferably 10.0% by mass or less, and still more preferably 9.0% by mass or less.

### <Rheology Control Agent>

The composition preferably contains a rheology control agent.

The rheology control agent is a component which imparts thixotropic properties to the composition, in which high viscosity is exhibited in a case where a shearing force (shear rate) is low and low viscosity is exhibited in a case where a shearing force (shear rate) is high.

In a case where the composition contains a rheology control agent, a content of the rheology control agent is preferably 0.01 to 10% by mass, more preferably 0.01 to 8.0% by mass, and still more preferably 0.01 to 6.0% by mass with respect to the total mass of the composition.

The content of the rheology control agent is preferably 0.01% to 10% by mass, more preferably 0.01% to 8.0% by mass, and still more preferably 0.01% to 6.0% by mass with respect to the total solid content of the composition.

The rheology control agent may be used alone or in combination of two or more kinds thereof.

Examples of the rheology control agent include an organic rheology control agent and an inorganic rheology control agent, and an organic rheology control agent is preferable.

### (Organic Rheology Control Agent)

Examples of the organic rheology control agent include a compound having one or more (preferably two or more) adsorptive groups and further having a steric repulsive structural group.

The adsorptive group interacts with the surface of the magnetic particles to adsorb the organic rheology control agent to the surface of the magnetic particles.

Examples of the above-described adsorptive group include an acid group, a basic group, and an amide group.

Examples of the acid group include a carboxy group, a phosphoric acid group, a sulfo group, a phenolic hydroxyl group, and an acid anhydride group thereof (an acid anhydride group of a carboxy group or the like), and from the viewpoint that the effect of the present invention is more excellent, a carboxy group is preferable.

Examples of the basic group include an amino group (a group obtained by removing one hydrogen atom from ammonia, a primary amine, or a secondary amine) and an imino group.

Among these, as the adsorptive group, a carboxy group or an amide group is preferable, and a carboxy group is more preferable.

Since the steric repulsive structural group has a sterically bulky structure, steric hindrance is introduced into the magnetic particles to which the organic rheology control agent is adsorbed, and an appropriate space is maintained between the magnetic particles. As the steric repulsive structural group, for example, a chain-like group is preferable, a long-chain fatty acid group is more preferable, and a long-chain alkyl group is still more preferable.

It is also preferable that the organic rheology control agent has a hydrogen-bonding unit.

The hydrogen-bonding unit is a partial structure which functions to construct a hydrogen-bonding network between the organic rheology control agents and between the organic rheology control agent and other components. The organic rheology control agent contributing to the formation of the network may or may not be adsorbed to the surface of the magnetic particles.

The hydrogen-bonding unit may be the same as or different from the above-described adsorptive group. In a case where the hydrogen-bonding unit is the same as the above-described adsorptive group, a part of the above-described adsorptive group is bonded to the surface of the magnetic particles, and another part functions as the hydrogen-bonding unit.

As the hydrogen-bonding unit, a carboxy group or an amide group is preferable. The carboxy group as the hydrogen-bonding unit is preferable from the viewpoint that the carboxy group is easily incorporated into a curing reaction in a case of producing a cured product, and the amide group is preferable from the viewpoint that temporal stability of the precursor composition is more excellent.

The organic rheology control agent is preferably one or more selected from the group consisting of a polycarboxylic acid (a compound having two or more carboxy groups), a polycarboxylic acid anhydride (a compound having two or more acid anhydride groups composed of carboxy groups), and an amide wax.

These compounds may be a resin or may be other than a resin.

In addition, these compounds may correspond to an aggregation control agent and/or an aggregation dispersant, which will be described later.

Examples of the organic rheology control agent include modified urea, urea-modified polyamide, fatty acid amide, polyurethane, polyamide amide, a polymer urea derivative, and salts thereof (carboxylic acid salts and the like).

The modified urea is a reaction product of an isocyanate monomer or an adduct thereof with an organic amine. The modified urea is modified with a polyoxyalkylene polyol (polyoxyethylene polyol, polyoxypropylene polyol, or the like) and/or an alkyd chain or the like. The urea-modified polyamide is, for example, a compound having a urea bond and a compound having a moderate polar group or a low polar group introduced at a terminal. Examples of the moderate polar group or the low polar group include a polyoxyalkylene polyol (polyoxyethylene polyol, polyoxypropylene polyol, or the like) and an alkyd chain. The fatty acid amide is a compound having a long-chain fatty acid group and an amide group in the molecule.

These compounds may be a resin or may be other than a resin.

In addition, these compounds may correspond to an aggregation control agent and/or an aggregation dispersant, which will be described later.

A molecular weight (in a case of having a molecular weight distribution, a weight-average molecular weight) of the organic rheology control agent is preferably in a range of 200 to 50,000.

In a case where the organic rheology control agent has an acid value, the acid value is preferably 5 to 400 mgKOH/g.

In a case where the organic rheology control agent has an amine value, the amine value is preferably 5 to 300 mgKOH/g.

### Aggregation Control Agent

Examples of the organic rheology control agent also include an aggregation control agent. The aggregation control agent may be a resin or may be other than a resin.

The aggregation control agent has a function of being bonded to an aggregate having a relatively high density, such as the magnetic particles, and on the other hand, of dispersing a component such as the reactive monomer in the composition, thereby making it possible to produce a bulky aggregate.

Examples of the aggregation control agent include a cellulose derivative.

Examples of the cellulose derivative include carboxymethyl cellulose, methyl cellulose, hydroxyethyl cellulose, hydroxypropyl cellulose, hydroxypropylmethyl cellulose, hydroxypropylethyl cellulose, and salts thereof.

### Aggregation Dispersant

Examples of the organic rheology control agent also include an aggregation dispersant.

The aggregation dispersant may be a resin or may be a substance other than a resin.

The aggregation dispersant has a function of being adsorbed on the surface of the magnetic particles, maintaining a distance between the magnetic particles at a certain level or more due to interaction between the dispersants while separating the magnetic particles from each other, and preventing the magnetic particles from being directly aggregated. As a result, aggregation of the magnetic particles is suppressed, and an aggregate having a relatively low density is formed even in a case where the aggregate is formed. The aggregation dispersant can further disperse components such as the reactive monomer in the composition to form a bulky aggregate, and thus the re-dispersibility can be improved.

As the aggregation dispersant, an alkylolammonium salt of a polybasic acid is preferable.

The polybasic acid may have two or more acid groups, and examples thereof include acidic polymers including a repeating unit having an acid group (for example, polyacrylic acid, polymethacrylic acid, polyvinylsulfonic acid, and polyphosphoric acid). In addition, examples of the polybasic acid other than those described above include polymers obtained by polymerizing an unsaturated fatty acid such as crotonic acid. The alkylolammonium salt of a polybasic acid is obtained by reacting these polybasic acids with alkylolammonium. The salt obtained by such a reaction usually includes the following partial structure.

—C(═O)—N(—R¹)(—R²—OH)

Here, R¹ is an alkyl group and R² is an alkylene group.

As the alkylolammonium salt of a polybasic acid, a polymer including a plurality of the above-described partial structures is preferable. In a case where the alkylolammonium salt of a polybasic acid is a polymer, a weight-average molecular weight is preferably 1,000 to 100,000 and more preferably 5,000 to 20,000. The polymer of the alkylolammonium salt of a polybasic acid is bonded to the surface of the magnetic particles and forms a hydrogen bond with another aggregation dispersant molecule such that the main chain structure of the polymer enters between the magnetic particles, and thus the magnetic particles can be separated from each other.

Examples of one suitable aspect of the aggregation dispersant include an amide wax which is a condensate obtained by a dehydration condensation of (a) saturated aliphatic monocarboxylic acids and hydroxy group-containing aliphatic monocarboxylic acids, (b) at least one acid of the polybasic acids, and (c) at least one amine of diamines and tetramines.

It is preferable that (a) to (c) are used such that a molar ratio of (a):(b):(c) is 1 to 3:0 to 5:1 to 6.

The number of carbon atoms in the saturated aliphatic monocarboxylic acids is preferably 12 to 22. Specific examples thereof include lauric acid, myristic acid, pentadecyl acid, palmitic acid, margaric acid, stearic acid, nonadecanoic acid, arachidic acid, and behenic acid.

The number of carbon atoms in the hydroxy group-containing aliphatic monocarboxylic acids is preferably 12 to 22. Specific examples thereof include 12-hydroxystearic acid and dihydroxystearic acid.

These saturated aliphatic monocarboxylic acids and hydroxy group-containing aliphatic monocarboxylic acids may be used alone or in combination of two or more kinds thereof.

The polybasic acid is preferably a carboxylic acid which is a dicarboxylic acid or higher and has 2 to 12 carbon atoms, and more preferably a dicarboxylic acid.

Examples of such a dicarboxylic acid include aliphatic dicarboxylic acids such as oxalic acid, malonic acid, succinic acid, glutaric acid, adipic acid, pimelic acid, suberic acid, azelaic acid, sebacic acid, 1,10-decanedicarboxylic acid, and 1,12-dodecanedicarboxylic acid; aromatic dicarboxylic acids such as phthalic acid, isophthalic acid, and terephthalic acid; and alicyclic dicarboxylic acids such as 1,2-cyclohexanedicarboxylic acid, 1,3-cyclohexanedicarboxylic acid, 1,4-cyclohexanedicarboxylic acid, and cyclohexylsuccinic acid.

These polybasic acids may be used alone or in combination of two or more kinds thereof.

The number of carbon atoms in the diamines is preferably 2 to 14. Specific examples thereof include ethylenediamine, 1,3-propanediamine, 1,4-butanediamine, hexamethylenediamine, metaxylenediamine, tolylenediamine, paraxylenediamine, phenylenediamine, isophoronediamine, 1,10-decanediamine, 1,12-dodecanediamine, 4,4-diaminodicyclohexyl methane, and 4,4-diaminodiphenyl methane.

The number of carbon atoms in the tetramines is preferably 2 to 14. Specific examples thereof include butane-1,1,4,4-tetramine, and pyrimidine-2, 4,5,6-tetramine.

These diamines and tetramines may be used alone or in combination of two or more thereof.

Amounts of the diamines and the tetramines are adjusted according to the number of moles of the saturated aliphatic monocarboxylic acid or the hydroxy group-containing aliphatic monocarboxylic acid and the number of moles of the polybasic acids, so that the total number of carboxy groups and the total number of amino groups are equivalent. For example, in a case of n mol (n=0 to 5) of an aliphatic dicarboxylic acid which is the polybasic acids with respect to 2 mol of an aliphatic monocarboxylic acid, and the diamines is (n+1) mol, the acid and the amine are equivalent.

The amide wax may be obtained as a mixture of a plurality of compounds having different molecular weights. The amide wax is preferably a compound represented by Chemical Formula (I). The amide wax may be a single compound or a mixture.

A-C—(B—C)ₘA (I)

In Formula (I), A is a dehydrated residual group of the saturated aliphatic monocarboxylic acid and/or the hydroxy group-containing saturated aliphatic monocarboxylic acid, B is a dehydrated residual group of the polybasic acid, C is a dehydrogenated residual group of the diamine and/or the tetramine, and m is 0≤m≤5.

Examples of one suitable aspect of the aggregation dispersant include a compound represented by Formula (II).

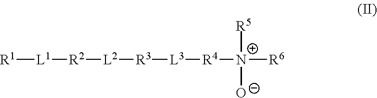

In Formula (II), R¹ represents a monovalent linear aliphatic hydrocarbon group having 10 to 25 carbon atoms, R² and R³ each independently represent a divalent aliphatic hydrocarbon group having 2, 4, 6, or 8 carbon atoms, a divalent alicyclic hydrocarbon group having 6 carbon atoms, or a divalent aromatic hydrocarbon group, R⁴ represents a divalent aliphatic hydrocarbon group having 1 to 8 carbon atoms, and R⁵ and R⁶ each independently represent a monovalent aliphatic hydrocarbon group having 1 to 3 carbon atoms or a hydroxyalkyl ether group.

In Formula (II), L¹ to L³ each independently represent an amide bond, and in a case where L¹ and L³ are each —CONH—, L² is —NHCO—, and in a case where L¹ and L³ are each —NHCO—, L² is —CONH—.

R¹ is a monovalent linear aliphatic hydrocarbon group having 10 to 25 carbon atoms, and examples thereof include a linear alkyl group such as a decyl group, a lauryl group, a myristyl group, a pentadecyl group, a stearyl group, a palmityl group, a nonadecyl group, an eicosyl group, and a behenyl group; a linear alkenyl group such as a decenyl group, a pentadecenyl group, an oleyl group, and an eicosenyl group; and a linear alkynyl group such as a pentadecynyl group, an octadecynyl group, and a nonadecinyl group.

Among these, R¹ is preferably a monovalent linear aliphatic hydrocarbon group having 14 to 25 carbon atoms, and more preferably a monovalent linear aliphatic hydrocarbon group having 18 to 21 carbon atoms. The linear aliphatic hydrocarbon group is preferably an alkyl group.

Examples of the divalent aliphatic hydrocarbon group having 2, 4, 6, or 8 carbon atoms in R² and R³ include an ethylene group, an n-butylene group, an n-hexylene group, and an n-octylene group.

Examples of the divalent alicyclic hydrocarbon group having 6 carbon atoms in R² and R³ include a 1,4-cyclohexylene group, a 1,3-cyclohexylene group, and a 1,2-cyclohexylene group.

Examples of the divalent aromatic hydrocarbon group in R² and R³ include an arylene group having 6 to 10 carbon atoms, such as a 1,4-phenylene group, a 1,3-phenylene group, and a 1,2-phenylene group.

Among these, from the viewpoint that an effect of improving viscosity is excellent, R² and R³ are each preferably a divalent aliphatic hydrocarbon group having 2, 4, 6, or 8 carbon atoms, more preferably a divalent aliphatic hydrocarbon group having 2, 4, or 6 carbon atoms, still more preferably a divalent aliphatic hydrocarbon group having 2 or 4 carbon atoms, and particularly preferably a divalent aliphatic hydrocarbon group having 2 carbon atoms. The divalent aliphatic hydrocarbon group is preferably a linear alkylene group.

R⁴ represents a divalent aliphatic hydrocarbon group having 1 to 8 carbon atoms, and among these, from the viewpoint that the effect of improving viscosity is excellent, a linear or branched alkylene group is preferable, and a linear alkylene group is more preferable.

In addition, the number of carbon atoms in the divalent aliphatic hydrocarbon group in R⁴ is 1 to 8, and from the viewpoint that the effect of improving viscosity is excellent, it is preferably 1 to 7, more preferably 3 to 7, still more preferably 3 to 6, and particularly preferably 3 to 5.

Accordingly, R⁴ is preferably a linear or branched alkylene group having 1 to 8 carbon atoms, more preferably a linear alkylene group having 1 to 7 carbon atoms, still more preferably a linear alkylene group having 3 to 7 carbon atoms, particularly preferably a linear alkylene group having 3 to 6 carbon atoms, and most preferably a linear alkylene group having 3 to 5 carbon atoms.

Examples of the monovalent aliphatic hydrocarbon group having 1 to 3 carbon atoms in R⁵ and R⁶ include a linear or branched alkyl group having 1 to 3 carbon atoms, such as a methyl group, an ethyl group, a propyl group, and an isopropyl group; a linear or branched alkenyl group having 2 or 3 carbon atoms, such as a vinyl group, a 1-methylvinyl group, and a 2-propenyl group; and a linear or branched alkynyl group having 2 or 3 carbon atoms, such as an ethynyl group and a propynyl group.

Examples of the hydroxyalkyl ether group in R⁵ and R⁶ include a mono- or di(hydroxy) Cia alkyl ether group such as a 2-hydroxyethoxy group, a 2-hydroxypropoxy group, and a 2,3-dihydroxypropoxy group.

Among these, R⁵ and R⁶ are each independently preferably a monovalent aliphatic hydrocarbon group having 1 to 3 carbon atoms, more preferably a linear or branched alkyl group having 1 to 3 carbon atoms, still more preferably a linear alkyl group having 1 to 3 carbon atoms, and particularly preferably a methyl group.

As the compound represented by Formula (II), compounds represented by Formulae (II-1) to (II-9) are preferable.

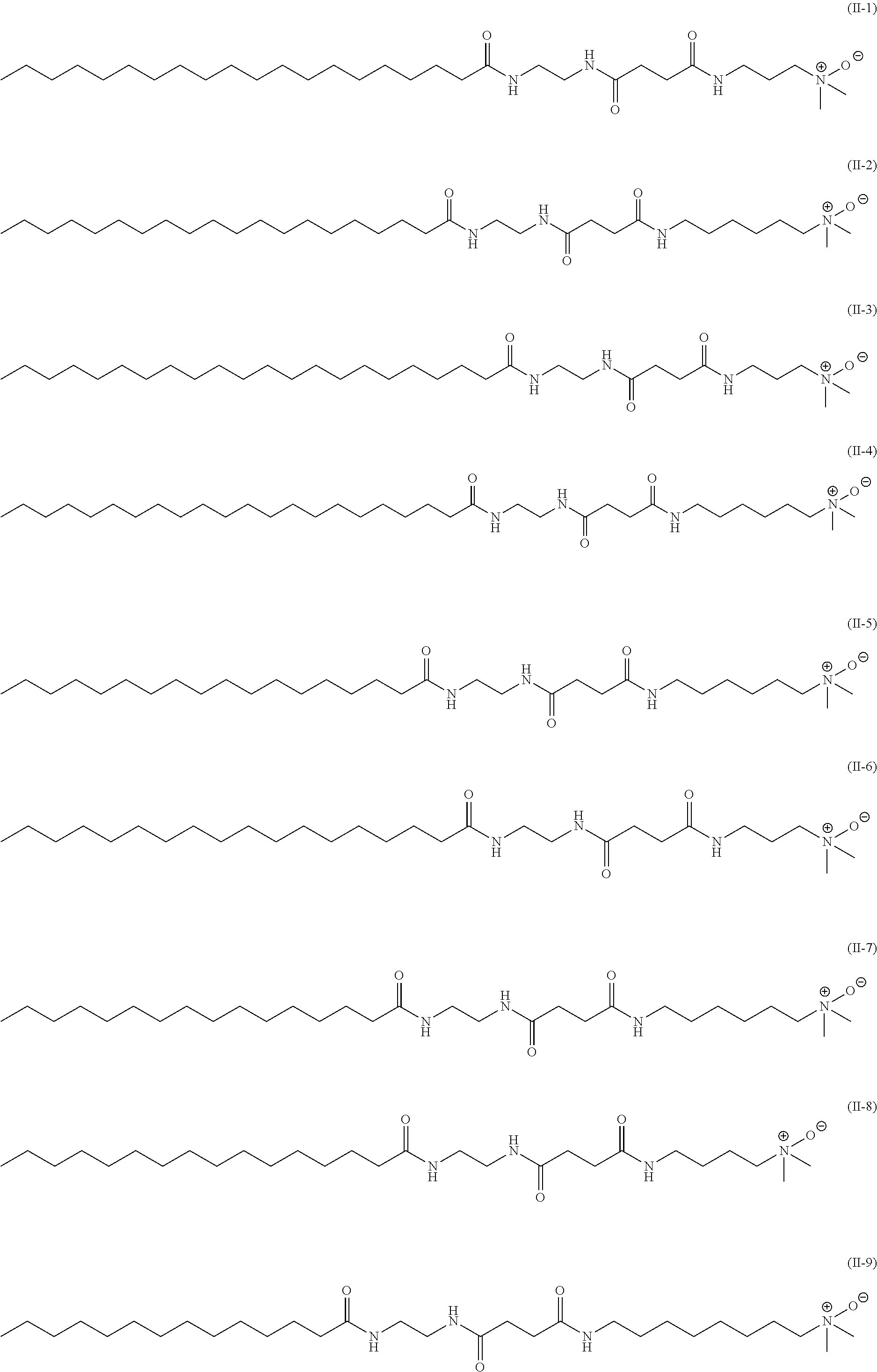

Examples of the aggregation dispersant include ANTI-TERRA-203, 204, 206, and 250 (all trade names, manufactured by BYK-Chemie GmbH); ANTI-TERRA-U (trade name, manufactured by BYK-Chemie GmbH); DISPER BYK-102, 180, and 191 (all trade names, manufactured by BYK-Chemie GmbH); BYK-P105 (trade name, manufactured by BYK-Chemie GmbH); TEGO Disper 630 and 700 (all trade names, manufactured by Evonik Degussa Japan Co., Ltd.); Talen VA-750B (trade name, manufactured by KYOEISHA CHEMICAL CO., LTD.); and FLOWNON RCM-100, RCM-300TL, and RCM-230AF (trade name, manufactured by KYOEISHA CHEMICAL CO., LTD., amide wax).

### (Inorganic Rheology Control Agent)

Examples of the inorganic rheology control agent include bentonite, silica, calcium carbonate, and smectite.

### <Dispersant>

The composition preferably contains a dispersant.

The dispersant is a resin which improves dispersibility of the magnetic particles, and usually has a functional group capable of interacting with the magnetic particles (for example, an acid group, a basic group, a coordinating group, a reactive functional group, and the like).

Examples of the acid group include a carboxylic acid group, a sulfonic acid group, a phosphoric acid group, and a phenolic hydroxyl group. Examples of the basic group include an amino group (a group obtained by removing one hydrogen atom from ammonia, a primary amine, or a secondary amine), an imino group, a heterocyclic ring including an N atom, and an amide group. Examples of the coordinating group and the reactive functional group include an acetoxyacetoxy group, a trialkoxysilyl group, an isocyanate group, an acid anhydride, and an acid chloride.

As the dispersant, a resin having an acidic group (in other words, an acidic dispersant) or a resin having a basic group (in other words, a basic dispersant) is preferable, and a resin having a basic group (a basic dispersant) is more preferable.

In a case where the dispersant has an acid group, an acid value of the dispersant is, for example, preferably 10 to 500 mgKOH/g and more preferably 30 to 400 mgKOH/g.

It is also preferable that the dispersant includes a repeating unit having a graft chain. That is, it is also preferable that the dispersant is a resin having a repeating unit having a graft chain (hereinafter, also referred to as “resin A”).

As the graft chain in the repeating unit having a graft chain is longer, the effect of steric repulsion, which improves the dispersibility of the magnetic particles, is higher. On the other hand, in a case where the graft chain is too long, an adsorption force to the magnetic particles decreases, and the dispersibility of the magnetic particles tends to decrease. Therefore, in the graft chain, the number of atoms excluding the hydrogen atoms is preferably 40 to 10,000, the number of atoms excluding the hydrogen atoms is more preferably 50 to 2,000, and the number of atoms excluding the hydrogen atoms is still more preferably 60 to 500.

Here, the graft chain refers to a portion from the base (in a group which is branched off from the main chain, an atom bonded to the main chain) of a main chain to the terminal of a group branched off from the main chain.

In addition, the graft chain preferably includes a polymer structure, and examples of such a polymer structure include a poly(meth)acrylate structure (for example, a poly(meth)acrylic structure), a polyester structure, a polyurethane structure, a polyurea structure, a polyamide structure, and a polyether structure.

In order to improve interaction between the graft chain and the solvent, thereby improving the dispersibility of the magnetic particles, the graft chain is preferably a graft chain including at least one selected from the group consisting of a polyester structure, a polyether structure, and a poly(meth)acrylate structure, and more preferably a graft chain including at least one of a polyester structure or a polyether structure.

The resin A may be a resin obtained using a macromonomer having a graft chain (monomer which has a polymer structure and constitutes a graft chain by being bonded to the main chain of).

The macromonomer having a graft chain (monomer which has a polymer structure and constitutes a graft chain by being bonded to the main chain of) is not particularly limited, but a macromonomer including a reactive double bond group can be suitably used.

As commercially available macromonomers which correspond to the above-described repeating unit having a graft chain and are suitably used for the synthesis of the resin A, AA-6, AA-10, AB-6, AS-6, AN-6, AW-6, AA-714, AY-707, AY-714, AK-5, AK-30, and AK-32 (all are trade names, manufactured by TOAGOSEI CO., LTD.), and BLEMMER PP-100, BLEMMER PP-500, BLEMMER PP-800, BLEMMER PP-1000, BLEMMER 55-PET-800, BLEMMER PME-4000, BLEMMER PSE-400, BLEMMER PSE-1300, and BLEMMER 43PAPE-600B (all are trade names, manufactured by NOF CORPORATION) are used. Among these, AA-6, AA-10, AB-6, AS-6, AN-6, or BLEMMER PME-4000 is preferable.

The resin A preferably includes at least one structure selected from the group consisting of polymethyl acrylate, polymethyl methacrylate, and a cyclic or chain-like polyester; more preferably has at least one structure selected from the group consisting of polymethyl acrylate, polymethyl methacrylate, and a chain-like polyester; and still more preferably has at least one structure selected from the group consisting of a polymethyl acrylate structure, a polymethyl methacrylate structure, a polycaprolactone structure, and a polyvalerolactone structure. The resin A may include the above-described structure alone, or may include a plurality of the above-described structures.

Here, the polycaprolactone structure refers to a structure including a structure, which is obtained by ring opening of ε-caprolactone, as a repeating unit. The polyvalerolactone structure refers to a structure including a structure, which is obtained by ring opening of 6-valerolactone, as a repeating unit.

In a case where the resin A includes repeating units represented by Formula (1) and Formula (2), which will be described later, in which each of j and k is 5, the above-described polycaprolactone structure can be introduced into the resin A.

In addition, in a case where the resin A includes repeating units represented by Formula (1) and Formula (2), which will be described later, in which each of j and k is 4, the above-described polyvalerolactone structure can be introduced into the resin.

In addition, in a case where the resin A includes a repeating unit represented by Formula (4), which will be described later, in which X⁵ is a hydrogen atom and R⁴ is a methyl group, the above-described polymethyl acrylate structure can be introduced into the resin A.

In addition, in a case where the resin A includes a repeating unit represented by Formula (4), which will be described later, in which X⁵ is a methyl group and R⁴ is a methyl group, the above-described polymethyl methacrylate structure can be introduced into the resin A.

In a case where the resin A includes a repeating unit represented by Formula (5), which will be described later, in which j in Formula (5) is 5, the above-described polycaprolactone structure can be introduced into the resin A.

In addition, in a case where the resin A includes a repeating unit represented by Formula (5), which will be described later, in which j in Formula (5) is 4, the above-described polyvalerolactone structure can be introduced into the resin.

In a case where the composition contains the resin A, a content of the resin A is preferably 1% to 24% by mass, preferably 0.001% to 20.0% by mass, more preferably 0.01% to 15.0% by mass, still more preferably 0.05% to 10.0% by mass, and particularly preferably 0.05% to 5.0% by mass with respect to the total mass of the composition.

The content of the resin A is preferably 0.001% to 20.0% by mass, more preferably 0.01% to 15.0% by mass, still more preferably 0.05% to 10.0% by mass, and particularly preferably 0.05% to 5.0% by mass with respect to the total solid content of the composition.

### (Resin A1)

Examples of one suitable aspect of the resin A include a resin including a repeating unit including a polyalkyleneimine structure and a polyester structure (hereinafter, “resin A1”). It is preferable that the repeating unit including a polyalkyleneimine structure and a polyester structure includes the polyalkyleneimine structure in a main chain and includes the polyester structure as a graft chain.

The above-described polyalkyleneimine structure is a polymerization structure including two or more identical or different alkyleneimine chains. Specific examples of the alkyleneimine chain include alkyleneimine chains represented by Formulae (4A) and (4B).

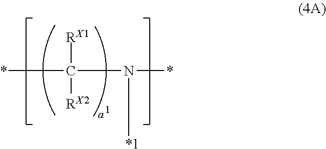

In Formula (4A), R^{X1} and R^{X2} each independently represent a hydrogen atom or an alkyl group. a¹ represents an integer of 2 or more. *¹ represents a bonding position with a polyester chain, an adjacent alkyleneimine chain, or with a hydrogen atom or a substituent.

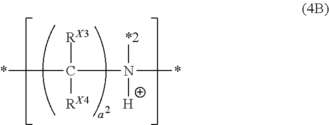

In Formula (4B), R^{X3} and R^{X4} each independently represent a hydrogen atom or an alkyl group. a² represents an integer of 2 or more. The alkyleneimine chain represented by Formula (4B) is bonded to a polyester chain having an anionic group by forming a salt-crosslinked group from N⁺ specified in Formula (4B) and the anionic group included in the polyester chain.

* in Formula (4A) and Formula (4B) and *² in Formula (4B) each independently represent a position where an adjacent alkyleneimine chain, or a hydrogen atom or a substituent is bonded.

Among these, * in Formula (4A) and Formula (4B) preferably represents a position where an adjacent alkyleneimine chain is bonded.

R^{X1} and R^{X2} in Formula (4A) and R^{X3} and R^{X4} in Formula (4B) each independently represent a hydrogen atom or an alkyl group.

The number of carbon atoms in the alkyl group is preferably 1 to 6 and preferably 1 to 3.

In Formula (4A), both R^{X1} and R^{X2} are preferably a hydrogen atom.

In Formula (4B), both R^{X3} and R^{X4} are preferably a hydrogen atom.

a¹ in Formula (4A) and a² in Formula (4B) are not particularly limited as long as they are an integer of 2 or more. The upper limit value thereof is preferably 10 or less, more preferably 6 or less, still more preferably 4 or less, even more preferably 2 or 3, and particularly preferably 2.

In Formula (4A) and Formula (4B), * represents a bonding position with an adjacent alkyleneimine chain or with a hydrogen atom or a substituent.

Examples of the above-described substituent include a substituent such as an alkyl group (for example, an alkyl group having 1 to 6 carbon atoms). In addition, a polyester chain may be bonded as the substituent.

The alkyleneimine chain represented by Formula (4A) is preferably linked to the polyester chain at the position of *¹ described above. Specifically, it is preferable that a carbonyl carbon in the polyester chain is bonded at the position of *¹ described above.

Examples of the above-described polyester chain include a polyester chain represented by Formula (5A).

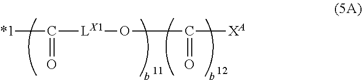

In a case where the alkyleneimine chain is the alkyleneimine chain represented by Formula (4B), it is preferable that the polyester chain includes an anionic group (preferably, oxygen anion O⁻), and this anionic group and N⁺ in Formula (4B) form a salt-crosslinked group.

Examples of such a polyester chain include a polyester chain represented by Formula (5B).

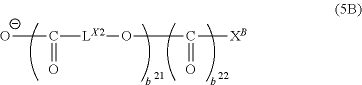

L^{X1} in Formula (5A) and L^{X2} in Formula (5B) each independently represent a divalent linking group. Preferred examples of the divalent linking group include an alkylene group having 3 to 30 carbon atoms.

b¹¹ in Formula (5A) and b²¹ in Formula (5B) each independently represent an integer of 2 or more, preferably an integer of 6 or more, and the upper limit thereof is, for example, 200 or less.

b¹² in Formula (5A) and b²² in Formula (5B) each independently represent 0 or 1.

X^{A} in Formula (5A) and X^{B} in Formula (5B) each independently represent a hydrogen atom or a substituent. Examples of the substituent include an alkyl group, an alkoxy group, a polyalkyleneoxyalkyl group, and an aryl group.

Examples of the number of carbon atoms in the above-described alkyl group (which may be linear, branched, or cyclic) and an alkyl group included in the above-described alkoxy group (which may be linear, branched, or cyclic) include 1 to 30, and 1 to 10 are preferable. In addition, the above-described alkyl group may further have a substituent, and examples of the substituent include a hydroxyl group and a halogen atom (including a fluorine atom, a chlorine atom, a bromine atom, an iodine atom, and the like).

The polyalkyleneoxyalkyl group is a substituent represented by R^{X6}(OR^{X7})ₚ(O)_{q}—. R^{X6} represents an alkyl group, R^{X7} represents an alkylene group, p represents an integer of 2 or more, and q represents 0 or 1.

The alkyl group represented by R^{X6} have the same definitions as the alkyl group represented by X^{A}. In addition, examples of the alkylene group represented by R^{X7} include a group obtained by removing one hydrogen atom from the alkyl group represented by X^{A}.

p is an integer of 2 or more, and the upper limit value thereof is, for example, 10 or less, preferably 5 or less.

Examples of the aryl group include an aryl group having 6 to 24 carbon atoms (which may be monocyclic or polycyclic).

The above-described aryl group may further have a substituent, and examples of the substituent include an alkyl group, a halogen atom, and a cyano group.

The above-described polyester chain preferably has a decyclized structure of a lactone such as ε-caprolactone, δ-caprolactone, β-propiolactone, γ-butyrolactone, δ-valerolactone, γ-valerolactone, enantholactone, β-butyrolactone, γ-hexanolactone, γ-octanolactone, δ-hexalanolactone, δ-octanolactone, δ-dodecanolactone, α-methyl-γ-butyrolactone, and lactide (which may be an L-form or a D-form), and more preferably has a decyclized structure of ε-caprolactone or δ-valerolactone.

The resin having a repeating unit including a polyalkyleneimine structure and a polyester structure can be synthesized according to the synthesis method described in JP5923557B.

As the resin having a repeating unit including a polyalkyleneimine structure and a polyester structure, reference can be made to a resin having a repeating unit including a polyalkyleneimine structure and a polyester structure, which is described in JP5923557B, the contents of which are incorporated into the present specification.

A weight-average molecular weight of the resin A1 is not particularly limited, but for example, 3,000 or more is preferable, 4,000 or more is more preferable, 5,000 or more is still more preferable, and 6,000 or more is particularly preferable. In addition, the upper limit value thereof is, for example, preferably 300,000 or less, more preferably 200,000 or less, still more preferably 100,000 or less, and particularly preferably 50,000 or less.

### (Resin A2)

In addition, examples of another suitable aspect of the resin A include a resin including a repeating unit having a graft chain shown below (hereinafter, “resin A2”).

### Repeating Unit Having Graft Chain

As the repeating unit having a graft chain, the resin A2 preferably includes a repeating unit represented by any of Formulae (1) to (4), and more preferably includes a repeating unit represented by any of Formula (1A), Formula (2A), Formula (3A), Formula (3B), or Formula (4).

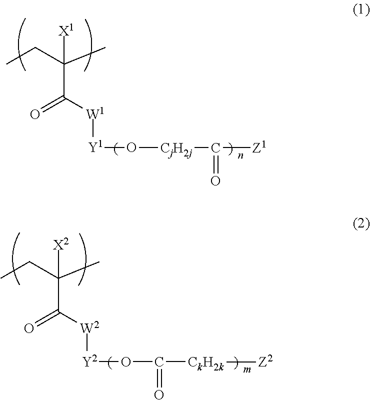

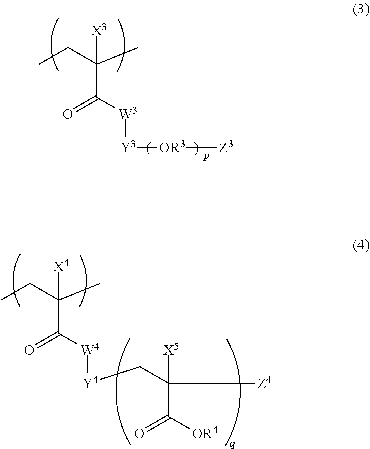

In Formulae (1) to (4), W¹, W², W³, and W⁴ each independently represent an oxygen atom or NH. W¹, W², W³, and W⁴ are preferably an oxygen atom.

In Formulae (1) to (4), X¹, X², X³, X⁴, and X⁵ each independently represent a hydrogen atom or a monovalent organic group. From the viewpoint of restriction on synthesis, X¹, X², X³, X⁴, and X⁵ are each independently preferably a hydrogen atom or an alkyl group having 1 to 12 carbon atoms (the number of carbon atoms), more preferably a hydrogen atom or a methyl group, and still more preferably a methyl group.

In Formulae (1) to (4), Y¹, Y², Y³, and Y⁴ each independently represent a divalent linking group, and the linking group has no particular restriction on a structure. Specific examples of the divalent linking groups represented by Y¹, Y², Y³, and Y⁴ include linking groups represented by the following (Y-1) to (Y-21). In the following structures, A and B each mean a bonding site bonded to the left terminal group and the right terminal group in Formulae (1) to (4). Among the structures shown below, from the viewpoint of simplicity of synthesis, (Y-2) or (Y-13) is more preferable.

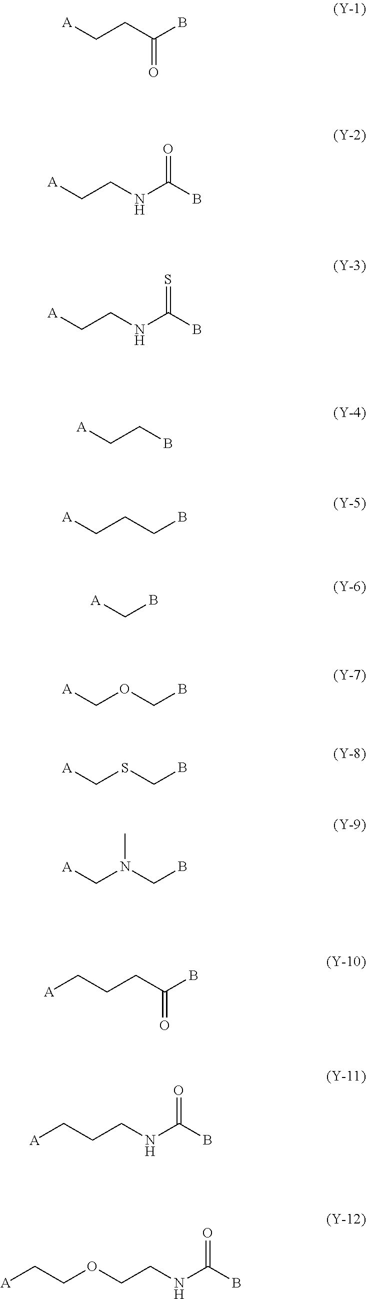

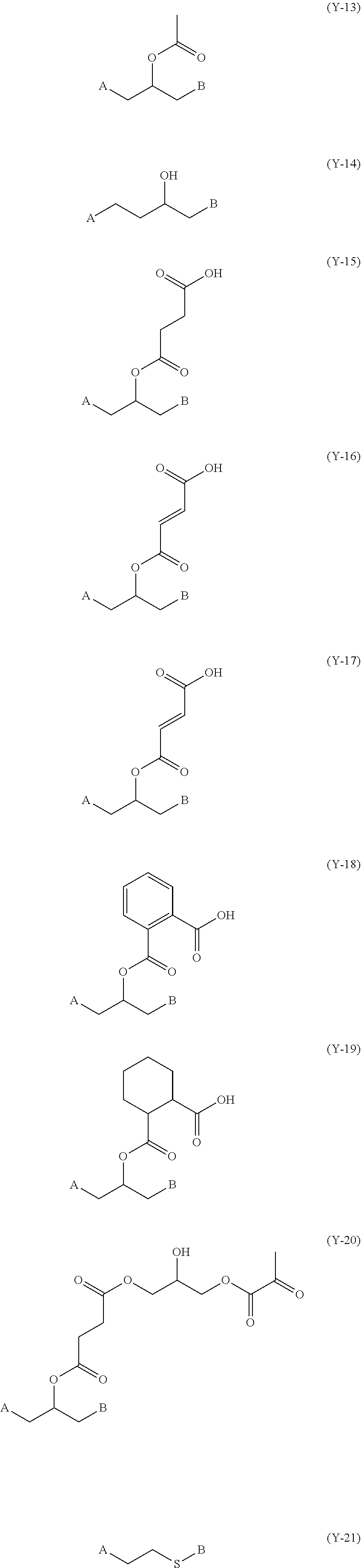

In Formulae (1) to (4), Z¹, Z², Z³, and Z⁴ each independently represent a hydrogen atom or a monovalent substituent. A structure of the above-described substituent is not particularly limited, but specific examples thereof include an alkyl group, a hydroxyl group, an alkoxy group, an aryloxy group, a heteroaryloxy group, an alkylthioether group, an arylthioether group, a heteroarylthioether group, and an amino group. Among these, particularly from the viewpoint of improvement in the dispersibility, the groups represented by Z¹, Z², Z³, and Z⁴ are each preferably a group exhibiting a steric repulsion effect, and more preferably each independently an alkyl group or alkoxy group having 5 to 24 carbon atoms, and, among them, in particular, still more preferably each independently a branched alkyl group having 5 to 24 carbon atoms, a cyclic alkyl group having 5 to 24 carbon atoms, or an alkoxy group having 5 to 24 carbon atoms. The alkyl group included in the alkoxy group may be linear, branched, or cyclic.

In addition, the substituent represented by Z¹, Z², Z³, and Z⁴ is also preferably a group containing a curable group such as a (meth)acryloyl group, an epoxy group, and/or an oxetanyl group. Examples of the above-described group containing a curable group include an “—O-alkylene group-(-O-alkylene group-)_{AL}-(meth)acryloyloxy group”. AL represents an integer of 0 to 5, and is preferably 1. The above-described alkylene groups preferably each independently have 1 to 10 carbon atoms. In a case where the above-described alkylene group has a substituent, the substituent is preferably a hydroxyl group.

The above-described substituent may be a group containing an onium structure.

The group containing an onium structure is a group having an anionic moiety and a cationic moiety. Examples of the anionic moiety include a partial structure containing an oxygen anion (—O⁻). Among these, the oxygen anion (—O⁻) is preferably directly bonded to a terminal of a repeating structure attached with n, m, p, or q in the repeating units represented by Formulae (1) to (4), and more preferably directly bonded to a terminal (that is, a right end in —(—O—CⱼH₂ⱼ—CO—)ₙ—) of a repeating structure attached with n in the repeating unit represented by Formula (1).

Examples of a cation of the cationic moiety of the group containing an onium structure include an ammonium cation. In a case where the cationic moiety is the ammonium cation, the cationic moiety is a partial structure containing a cationic nitrogen atom (>N⁺<). The cationic nitrogen atom (>N⁺<) is preferably bonded to four substituents (preferably, organic groups), and it is preferable that one to four among the substituents are each an alkyl group having 1 to 15 carbon atoms. In addition, it is also preferable that one or more (preferably, one) of the four substituents are a group containing a curable group such as a (meth)acryloyl group, an epoxy group, and/or an oxetanyl group. Examples of the above-described group containing a curable group, which can be adopted as the above-described substituent, include “—O-alkylene group-(-O-alkylene group-)_{AL}-(meth)acryloyloxy group” described above and “-alkylene group-(-O-alkylene group-)_{AL1}-(meth)acryloyloxy group”. AL1 represents an integer of 1 to 5, and is preferably 1. The above-described alkylene groups preferably each independently have 1 to 10 carbon atoms. In a case where the above-described alkylene group has a substituent, the substituent is preferably a hydroxyl group.

In Formulae (1) to (4), n, m, p, and q are each independently an integer of 1 to 500.

In addition, in Formulae (1) and (2), j and k each independently represent an integer of 2 to 8. Each of j and k in Formulae (1) and (2) is preferably an integer of 4 to 6, and more preferably 5.

In addition, in Formulae (1) and (2), each of n and m is, for example, an integer of 2 or more, preferably an integer of 6 or more, more preferably an integer of 10 or more, and still more preferably an integer of 20 or more. In addition, in a case where the resin A2 includes a polycaprolactone structure and a polyvalerolactone structure, the sum of the repetition number of the polycaprolactone structure and the repetition number of the polyvalerolactone structure is preferably an integer of 10 or more and more preferably an integer of 20 or more.

In Formula (3), R³ represents a branched or linear alkylene group, and is preferably an alkylene group having 1 to 10 carbon atoms and more preferably an alkylene group having 2 or 3 carbon atoms. In a case where p is 2 to 500, a plurality of R³'s may be the same or different from each other.

In Formula (4), R⁴ represents a hydrogen atom or a monovalent organic group, and the structure of the monovalent substituent is not particularly limited. As R⁴, a hydrogen atom, an alkyl group, an aryl group, or a heteroaryl group is preferable, and a hydrogen atom or an alkyl group is more preferable. In a case where R⁴ is an alkyl group, as the alkyl group, a linear alkyl group having 1 to 20 carbon atoms, a branched alkyl group having 3 to 20 carbon atoms, or a cyclic alkyl group having 5 to 20 carbon atoms is preferable, a linear alkyl group having 1 to 20 carbon atoms is more preferable, and a linear alkyl group having 1 to 6 carbon atoms is still more preferable. In a case where q in Formula (4) is 2 to 500, a plurality of X⁵'s and a plurality of R⁴'s in the graft chain may be the same or different from each other, respectively.

The resin A2 may include two or more repeating units having a graft chain, each of which has different structures. That is, the repeating units which are represented by Formulae (1) to (4) and have structures different from one another may be included in a molecule of the resin A2, and in a case where n, m, p, and q in Formulae (1) to (4) each represent an integer equal to or greater than 2, in Formulae (1) and (2), structures in which j and k are different from each other may be included in the side chain, and in Formulae (3) and (4), a plurality of R³'s, a plurality of R⁴'s, and a plurality of X⁵'s in the molecule may be respectively the same or different from each other.

The repeating unit represented by Formula (1) is more preferably a repeating unit represented by Formula (1A).

In addition, the repeating unit represented by Formula (2) is more preferably a repeating unit represented by Formula (2A).

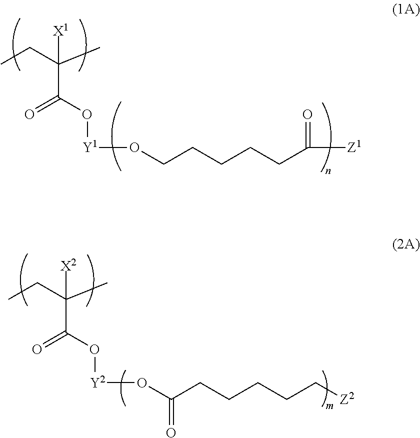

X¹, Y¹, Z¹, and n in Formula (1A) have the same definitions as X¹, Y¹, Z¹, and n in Formula (1), and preferred ranges thereof are also the same. X², Y², Z², and m in Formula (2A) have the same definitions as X², Y², Z², and m in Formula (2), and preferred ranges thereof are also the same.

In addition, the repeating unit represented by Formula (3) is more preferably a repeating unit represented by Formula (3A) or Formula (3B).

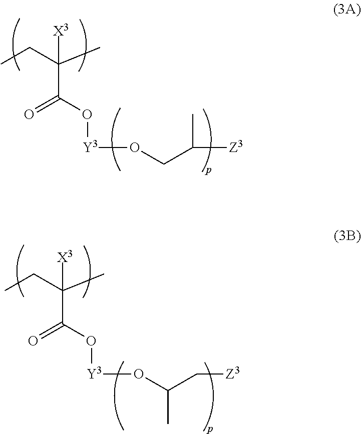

X³, Y³, Z³, and p in Formula (3A) or (3B) have the same definitions as X³, Y³, Z³, and p in Formula (3), and preferred ranges thereof are also the same.

It is more preferable that the resin A2 includes the repeating unit represented by Formula (1A) as the repeating unit having a graft chain.

In a case where the resin A2 includes the repeating unit represented by Formulae (1) to (4) described above, it is also preferable that the resin A further include, as another repeating unit having a graft chain, a repeating unit represented by Formula (5).

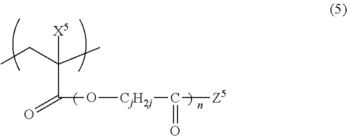

In Formula (5), n represents an integer of 1 to 50, preferably an integer of 2 to 30, more preferably an integer of 2 to 10, and still more preferably an integer of 2 to 5.

In addition, j represents an integer of 2 to 8, and preferably an integer of 4 to 6 and more preferably 5.

In addition, in Formula (5), X⁵ and Z⁵ have the same definitions as X¹ and Z¹ in Formula (1) respectively, and suitable aspects thereof are also the same.

In the resin A2, a content of the repeating unit having a graft chain in terms of mass is, for example, 2% to 100% by mass, preferably 2% to 95% by mass, more preferably 2% to 90% by mass, and still more preferably 5% to 30% by mass with respect to the total mass of the resin A2. The effect of the present invention is more excellent in a case where the repeating unit having a graft chain is contained in the range.

### Hydrophobic Repeating Unit

In addition, the resin A2 may include a hydrophobic repeating unit which is different from the repeating unit having a graft chain (that is, the hydrophobic repeating unit does not correspond to the repeating unit having a graft chain). Here, in the present specification, the hydrophobic repeating unit is a repeating unit which does not have an acid group (for example, a carboxylic acid group, a sulfonic acid group, a phosphoric acid group, a phenolic hydroxyl group, or the like).

The hydrophobic repeating unit is preferably a repeating unit derived from (corresponding to) a compound (monomer) having a C log P value of 1.2 or more, and more preferably a repeating unit derived from a compound having a C log P value of 1.2 to 8. By doing so, the effects of the present invention can be more reliably exhibited.

The C log P value is a value calculated by a program “C LOG P” available from Daylight Chemical Information System, Inc. This program provides a value of “calculated log P” calculated by the fragment approach (see the following documents) of Hansch and Leo. The fragment approach is based on a chemical structure of a compound, and the log P value of the compound is estimated by dividing the chemical structure into partial structures (fragments) and summing up degrees of contribution to log P which are assigned to the fragments. Details thereof are described in the following documents. In the present specification, a C log P value calculated by a program C LOG P v4.82 is used.

A. J. Leo, Comprehensive Medicinal Chemistry, Vol. 4, C. Hansch, P. G. Sammnens, J. B. Taylor and C. A. Ramsden, Eds., p. 295, Pergamon Press, 1990, C. Hansch & A. J. Leo. Substituent Constants For Correlation Analysis in Chemistry and Biology. John Wiley & Sons. A. J. Leo. Calculating logPoct from structure. Chem. Rev., 93, 1281 to 1306, 1993.

The log P refers to a common logarithm of a partition coefficient P, is a physical property value that shows how a certain organic compound is partitioned in an equilibrium of a two-phase system consisting of oil (generally, 1-octanol) and water by using a quantitative numerical value, and is expressed by the following expression.

log P=log(Coil/Cwater)

In the expression, Coil represents a molar concentration of a compound in an oil phase, and Cwater represents a molar concentration of the compound in a water phase.

The greater the positive log P value based on 0, the higher the oil solubility, and the greater the absolute value of negative log P, the higher the water solubility. Accordingly, the value of log P has a negative correlation with the water solubility of an organic compound and is widely used as a parameter for estimating the hydrophilicity and hydrophobicity of an organic compound.

The resin A2 preferably includes, as the hydrophobic repeating unit, one or more repeating units selected from repeating units derived from monomers represented by Formulae (i) to (iii).

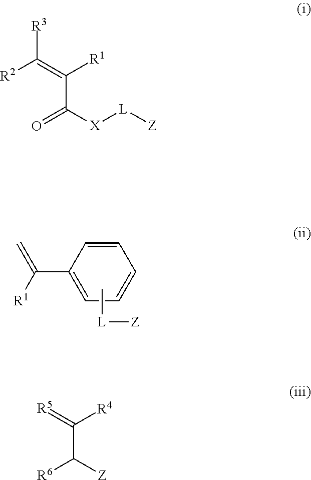

In Formulae (i) to (iii), R¹, R², and R³ each independently represent a hydrogen atom, a halogen atom (for example, a fluorine atom, a chlorine atom, a bromine atom, or the like), or an alkyl group (for example, a methyl group, an ethyl group, a propyl group, or the like) having 1 to 6 carbon atoms.

R¹, R², and R³ are each preferably a hydrogen atom or an alkyl group having 1 to 3 carbon atoms, and more preferably a hydrogen atom or a methyl group. R² and R³ are each still more preferably a hydrogen atom.

X represents an oxygen atom (—O—) or an imino group (—NH—), and is preferably an oxygen atom.

L is a single bond or a divalent linking group. Examples of the divalent linking group include a divalent aliphatic group (for example, an alkylene group, a substituted alkylene group, an alkenylene group, a substituted alkenylene group, an alkynylene group, or a substituted alkynylene group), a divalent aromatic group (for example, an arylene group or a substituted arylene group), a divalent heterocyclic group, an oxygen atom (—O—), a sulfur atom (—S—), an imino group (—NH—), a substituted imino group (—NR³¹—, where R³¹ is an aliphatic group, an aromatic group, or a heterocyclic group), a carbonyl group (—CO—), and a combination thereof.

The divalent aliphatic group may have a cyclic structure or a branched structure. The number of carbon atoms in the aliphatic group is preferably 1 to 20, more preferably 1 to 15, and still more preferably 1 to 10. The aliphatic group may be an unsaturated aliphatic group or a saturated aliphatic group, but is preferably a saturated aliphatic group. In addition, the aliphatic group may have a substituent. Examples of the substituent include a halogen atom, an aromatic group, and a heterocyclic group.

The number of carbon atoms in the divalent aromatic group is preferably 6 to 20, more preferably 6 to 15, and still more preferably 6 to 10. In addition, the aromatic group may have a substituent. Examples of the substituent include a halogen atom, an aliphatic group, an aromatic group, and a heterocyclic group.

It is preferable that the divalent heterocyclic group includes a 5-membered ring or a 6-membered ring as a heterocyclic ring. The heterocyclic ring may be fused with another heterocyclic ring, an aliphatic ring, or an aromatic ring. In addition, the heterocyclic group may have a substituent. Examples of the substituent include a halogen atom, a hydroxyl group, an oxo group (═O), a thioxo group (═S), an imino group (═NH), a substituted imino group (=N—R³², where R³² is an aliphatic group, an aromatic group, or a heterocyclic group), an aliphatic group, an aromatic group, and a heterocyclic group.

L is preferably a single bond, an alkylene group, or a divalent linking group having an oxyalkylene structure. The oxyalkylene structure is more preferably an oxyethylene structure or an oxypropylene structure. In addition, L may have a polyoxyalkylene structure which includes two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—, and n is preferably an integer of 2 or more and more preferably an integer of 2 to 10.

Examples of Z include an aliphatic group (for example, an alkyl group, a substituted alkyl group, an unsaturated alkyl group, or a substituted unsaturated alkyl group), an aromatic group (for example, an aryl group, a substituted aryl group, an arylene group, or a substituted arylene group), a heterocyclic group, and a combination thereof. These groups may contain an oxygen atom (—O—), a sulfur atom (—S—), an imino group (—NH—), a substituted imino group (—NR³¹—, where R³¹ is an aliphatic group, an aromatic group, or a heterocyclic group), or a carbonyl group (—CO—).

The aliphatic group may have a cyclic structure or a branched structure. The number of carbon atoms in the aliphatic group is preferably 1 to 20, more preferably 1 to 15, and still more preferably 1 to 10. The aliphatic group further contains a ring assembly hydrocarbon group or a crosslinked cyclic hydrocarbon group, and examples of the ring assembly hydrocarbon group include a bicyclohexyl group, a perhydronaphthalenyl group, a biphenyl group, and a 4-cyclohexylphenyl group. Examples of a crosslinked cyclic hydrocarbon ring include a bicyclic hydrocarbon ring such as pinane, bornane, norpinane, norbornane, and bicyclooctane rings (a bicyclo [2.2.2]octane ring, a bicyclo[3.2.1]octane ring, or the like); a tricyclic hydrocarbon ring such as homobredane, adamantane, tricyclo[5.2.1.0^{2,6}]decane, and tricyclo[4.3.1.1^{2,5}]undecane rings; and a tetracyclic hydrocarbon ring such as tetracyclo[4.4.0.1^{2,5}.1^{7,10}]dodecane and perhydro-1,4-methano-5,8-methanonaphthalene rings.

In addition, the crosslinked cyclic hydrocarbon ring also includes a fused cyclic hydrocarbon ring, for example, a fused ring in which a plurality of 5- to 8-membered cycloalkane rings, such as perhydronaphthalene (decalin), perhydroanthracene, perhydrophenanthrene, perhydroacenaphthene, perhydrofluorene, perhydroindene, and perhydrophenalene rings, are fused.

As the aliphatic group, a saturated aliphatic group is preferable to an unsaturated aliphatic group. In addition, the aliphatic group may have a substituent. Examples of the substituent include a halogen atom, an aromatic group, and a heterocyclic group. Here, the aliphatic group does not have an acid group as a substituent.

The number of carbon atoms in the aromatic group is preferably 6 to 20, more preferably 6 to 15, and still more preferably 6 to 10. In addition, the aromatic group may have a substituent. Examples of the substituent include a halogen atom, an aliphatic group, an aromatic group, and a heterocyclic group. Here, the aromatic group does not have an acid group as a substituent.

It is preferable that the heterocyclic group includes a 5-membered ring or a 6-membered ring as a heterocyclic ring. The heterocyclic ring may be fused with another heterocyclic ring, an aliphatic ring, or an aromatic ring. In addition, the heterocyclic group may have a substituent. Examples of the substituent include a halogen atom, a hydroxyl group, an oxo group (=O), a thioxo group (=S), an imino group (=NH), a substituted imino group (=N—R³², where R³² is an aliphatic group, an aromatic group, or a heterocyclic group), an aliphatic group, an aromatic group, and a heterocyclic group. Here, the heterocyclic group does not have an acid group as a substituent.

In Formula (iii), R⁴, R⁵, and R⁶ each independently represent a hydrogen atom, a halogen atom (for example, a fluorine atom, a chlorine atom, a bromine atom, or the like), an alkyl group (for example, a methyl group, an ethyl group, a propyl group, or the like) having 1 to 6 carbon atoms, Z, or L-Z. Here, L and Z have the same definitions as the groups described above. R⁴, R⁵, and R⁶ are each preferably a hydrogen atom or an alkyl group having 1 to 3 carbon atoms, and more preferably a hydrogen atom.

The monomer represented by Formula (i) is preferably a compound in which R¹, R², and R³ are each a hydrogen atom or a methyl group, L is a single bond, an alkylene group, or a divalent linking group having an oxyalkylene structure, X is an oxygen atom or an imino group, and Z is an aliphatic group, a heterocyclic group, or an aromatic group.

The monomer represented by Formula (ii) is preferably a compound in which R¹ is a hydrogen atom or a methyl group, L is an alkylene group, and Z is an aliphatic group, a heterocyclic group, or an aromatic group. In addition, the monomer represented by Formula (iii) is preferably a compound in which R⁴, R⁵, and R⁶ are each a hydrogen atom or a methyl group, and Z is an aliphatic group, a heterocyclic group, or an aromatic group.

Examples of typical compounds represented by Formulae (i) to (iii) include radically polymerizable compounds selected from acrylic acid esters, methacrylic acid esters, and styrenes.

Furthermore, regarding the examples of the typical compounds represented by Formulae (i) to (iii), reference can be made to the compounds described in paragraphs 0089 to 0093 of JP2013-249417A, the contents of which are incorporated into the present specification.

In the resin A2, a content of the hydrophobic repeating unit, in terms of mass is preferably 10% to 90% by mass and more preferably 20% to 80% by mass with respect to the total mass of the resin A2.

Functional Group Capable of Interacting with Magnetic Particles

The resin A2 preferably has a functional group capable of interacting with the magnetic particles.

It is preferable that the resin A2 further include a repeating unit including a functional group capable of interacting with the magnetic particles.

Examples of the functional group capable of interacting with the magnetic particles include an acid group, a basic group, a coordinating group, and a reactive functional group.

In a case where the resin A2 includes an acid group, a basic group, a coordinating group, or a reactive functional group, it is preferable that the resin A2 includes a repeating unit including an acid group, a repeating unit including a basic group, a repeating unit including a coordinating group, or a repeating unit including a reactive functional group, respectively.

The repeating unit including an acid group may be a repeating unit which is the same or different from the above-described repeating unit having a graft chain. However, the repeating unit including an acid group is a repeating unit different from the above-described hydrophobic repeating unit (that is, the repeating unit including an acid group does not correspond to the above-described hydrophobic repeating unit).

Examples of the acid group which is the functional group capable of interacting with the magnetic particles include a carboxylic acid group, a sulfonic acid group, a phosphoric acid group, and a phenolic hydroxyl group; and at least one of a carboxylic acid group, a sulfonic acid group, or a phosphoric acid group is preferable, and a carboxylic acid group is more preferable.

The resin A2 may have one or two or more kinds of the repeating unit including an acid group.

In a case where the resin A2 includes a repeating unit including an acid group, a content thereof in terms of mass is preferably 5% to 80% by mass and more preferably 10% to 60% by mass with respect to the total mass of the resin A2.

Examples of the basic group which is the functional group capable of interacting with the magnetic particles include an amino group (a group obtained by removing one hydrogen atom from ammonia, a primary amine, or a secondary amine), a heterocyclic ring including an N atom, and an amide group; and from the viewpoint of favorable adsorption force to the magnetic particles and high dispersibility, an amino group is preferable as the basic group.

The resin A2 may include one or two or more kinds of the basic group.

In a case where the resin A2 includes a repeating unit including a basic group, a content thereof in terms of mass is preferably 0.01% to 50% by mass and more preferably 0.01% to 30% by mass with respect to the total mass of the resin A2.

Examples of the coordinating group and the reactive functional group which are the functional groups capable of interacting with the magnetic particles include an acetyl acetoxy group, a trialkoxysilyl group, an isocyanate group, an acid anhydride, and an acid chloride. Among these, as the coordinating group and the reactive functional group, an acetylacetoxy group is preferable from the viewpoint that the adsorption force to the magnetic particles is favorable and the dispersibility of the magnetic particles is high.

The resin A2 may have one or two or more kinds of the coordinating group and the reactive functional group.

In a case where the resin A2 includes the repeating unit including a coordinating group and/or the repeating unit including a reactive functional group, a content thereof in terms of mass is preferably 10% to 80% by mass and more preferably 20% to 60% by mass with respect to the total mass of the resin A2.

In a case where the above-described resin A2 includes a functional group capable of interacting with the magnetic particles, in addition to the graft chain, it is sufficient that the resin A2 includes the functional group capable of interacting with various magnetic particles described above, and a method of introducing these functional groups is not particularly limited. As the above-described resin A2, for example, an aspect in which the resin A2 includes one or more kinds of repeating units selected from repeating units derived from monomers represented by Formulae (iv) to (vi) is also preferable.

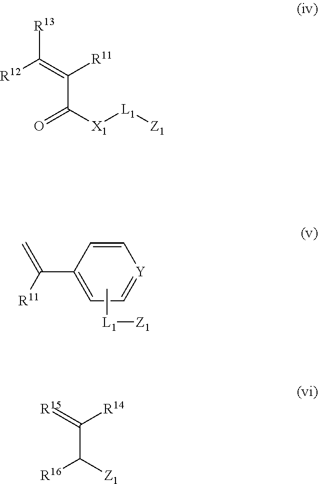

In Formulae (iv) to (vi), R¹¹, R¹², and R¹³ each independently represent a hydrogen atom, a halogen atom (for example, a fluorine atom, a chlorine atom, a bromine atom, or the like), or an alkyl group (for example, a methyl group, an ethyl group, a propyl group, or the like) having 1 to 6 carbon atoms.

In Formulae (iv) to (vi), R¹¹, R¹², and R¹³ are each preferably a hydrogen atom or an alkyl group having 1 to 3 carbon atoms, and more preferably a hydrogen atom or a methyl group. In General Formula (iv), R¹² and R¹³ are each still more preferably a hydrogen atom.

In Formula (iv), X₁ represents an oxygen atom (—O—) or an imino group (—NH—), and is preferably an oxygen atom.

In addition, in Formula (v), Y represents a methine group or a nitrogen atom.

In addition, in Formulae (iv) and (v), L₁ represents a single bond or a divalent linking group. The divalent linking group has the same definition as the divalent linking group represented by L in Formula (i) described above.

L₁ is preferably a single bond, an alkylene group, or a divalent linking group having an oxyalkylene structure. The oxyalkylene structure is more preferably an oxyethylene structure or an oxypropylene structure. In addition, L₁ may have a polyoxyalkylene structure which includes two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—, and n is preferably an integer of 2 or more and more preferably an integer of 2 to 10.

In Formulae (iv) and (vi), Z₁ represents a functional group which can interact with the magnetic particles in addition to the graft chain, and a carboxylic acid group or an amino group is preferable.

In Formula (vi), R¹⁴, R¹⁵, and R¹⁶ each independently represent a hydrogen atom, a halogen atom (for example, a fluorine atom, a chlorine atom, a bromine atom, or the like), an alkyl group (for example, a methyl group, an ethyl group, a propyl group, or the like) having 1 to 6 carbon atoms, —Z₁, or L₁-Z₁. Here, L₁ and Z₁ have the same definitions as L₁ and Z₁ described above, and preferred examples thereof are also the same. R¹⁴, R¹⁵, and R¹⁶ are each preferably a hydrogen atom or an alkyl group having 1 to 3 carbon atoms, and more preferably a hydrogen atom.

The monomer represented by Formula (iv) is preferably a compound in which R¹¹, R¹², and R¹³ are each independently a hydrogen atom or a methyl group, L₁ is an alkylene group or a divalent linking group having an oxyalkylene structure, X₁ is an oxygen atom or an imino group, and Z₁ is a carboxylic acid group.

In addition, the monomer represented by Formula (v) is preferably a compound in which R¹¹ is a hydrogen atom or a methyl group, L₁ is an alkylene group, Z₁ is a carboxylic acid group, and Y is a methine group.

Furthermore, the monomer represented by Formula (vi) is preferably a compound in which R¹⁴, R¹⁵, and R¹⁶ are each independently a hydrogen atom or a methyl group and Z₁ is a carboxylic acid group.

Typical examples of the monomers (compounds) represented by Formulae (iv) to (vi) are shown below.

Examples of the monomers include methacrylic acid, crotonic acid, isocrotonic acid, a reaction product of a compound (for example, 2-hydroxyethyl methacrylate) including an addition polymerizable double bond and a hydroxyl group in a molecule with a succinic acid anhydride, a reaction product of a compound containing an addition polymerizable double bond and a hydroxyl group in a molecule with a phthalic acid anhydride, a reaction product of a compound containing an addition polymerizable double bond and a hydroxyl group in a molecule with a tetrahydroxyphthalic acid anhydride, a reaction product of a compound including an addition polymerizable double bond and a hydroxyl group in a molecule with trimellitic acid anhydride, a reaction product of a compound including an addition polymerizable double bond and a hydroxyl group in a molecule with a pyromellitic acid anhydride, acrylic acid, an acrylic acid dimer, an acrylic acid oligomer, maleic acid, itaconic acid, fumaric acid, 4-vinylbenzoic acid, vinyl phenol, and 4-hydroxyphenyl methacrylamide.

From the viewpoint of interaction with the magnetic particles, temporal stability, and permeability to the developer, a content of the repeating unit a functional group capable of interacting with the magnetic particles in terms of mass is preferably 0.05% to 90% by mass, more preferably 1.0% to 80% by mass, and still more preferably 10% to 70% by mass with respect to the total mass of the resin A2.

### Ethylenically Unsaturated Group

The resin A2 may include an ethylenically unsaturated group.

The ethylenically unsaturated group is not particularly limited, and examples thereof include a (meth)acryloyl group, a vinyl group, and a styryl group; and a (meth)acryloyl group is preferable.

Among these, the resin A2 preferably includes a repeating unit which includes an ethylenically unsaturated group on a side chain; and more preferably includes a repeating unit which includes an ethylenically unsaturated group on a side chain and is derived from (meth)acrylate (hereinafter, also referred to as “(meth)acrylic repeating unit including an ethylenically unsaturated group on a side chain”).

The (meth)acrylic repeating unit including an ethylenically unsaturated group on a side chain is obtained, for example, by causing an addition reaction between the above-described carboxylic acid group in the resin A2 including a (meth)acrylic repeating unit including the carboxylic acid group and an ethylenically unsaturated compound including a glycidyl group or an alicyclic epoxy group. The (meth)acrylic repeating unit including an ethylenically unsaturated group on a side chain can be obtained by reacting the ethylenically unsaturated group (glycidyl group or alicyclic epoxy group) introduced in this manner.

In a case where the resin A2 includes a repeating unit including an ethylenically unsaturated group, a content thereof in terms of mass is preferably 30% to 70% by mass and more preferably 40% to 60% by mass with respect to the total mass of the resin A2.

### Other Curable Groups

The resin A2 may include a curable group in addition to the ethylenically unsaturated group.

Examples of other curable groups include an epoxy group and an oxetanyl group.

Among these, the resin A2 preferably includes a repeating unit which includes the other curable groups on a side chain; and more preferably includes a repeating unit which includes the other curable groups on a side chain and is derived from (meth)acrylate (hereinafter, also referred to as “(meth)acrylic repeating unit including the other curable groups on a side chain”).

Examples of the (meth)acrylic repeating unit including the other curable groups on a side chain include a repeating unit derived from glycidyl (meth)acrylate.

In a case where the resin A2 includes a repeating unit including other curable groups, a content thereof in terms of mass is preferably 5% to 50% by mass and more preferably 10% to 30% by mass with respect to the total mass of the resin A2.

### Other Repeating Units

Furthermore, for the purpose of improving various performances such as a film forming ability, as long as the effect of the present invention is not impaired, the resin A2 may further have other repeating units having various functions, which are different from the above-mentioned repeating units.

Examples of such other repeating units include repeating units derived from radically polymerizable compounds selected from acrylonitriles, methacrylonitriles, and the like.

For the resin A2, one or two or more kinds of the other repeating units can be used, and a content thereof in terms of mass is preferably 0% to 80% by mass and more preferably 10% to 60% by mass with respect to the total mass of the resin A2.

### Physical Properties of Resin A2

An acid value of the resin A2 is not particularly limited, but is, for example, preferably in a range of 0 to 400 mgKOH/g, more preferably in a range of 10 to 350 mgKOH/g, still more preferably in a range of 30 to 300 mgKOH/g, and particularly preferably in a range of 50 to 200 mgKOH/g.

In a case where the acid value of the resin A2 is 50 mgKOH/g or more, sedimentation stability of the magnetic particles can be further improved.

In the present specification, the acid value can be calculated, for example, from the average content of acid groups in the compound. In addition, a resin having a desired acid value can be obtained by changing the content of the repeating unit including an acid group in the resin.

A weight-average molecular weight of the resin A2 is not particularly limited, but for example, 3,000 or more is preferable, 4,000 or more is more preferable, 5,000 or more is still more preferable, and 6,000 or more is particularly preferable. In addition, the upper limit value thereof is, for example, preferably 300,000 or less, more preferably 200,000 or less, still more preferably 100,000 or less, and particularly preferably 50,000 or less.

The resin A2 can be synthesized based on a known method.

Regarding specific examples of the resin A2, reference can be made to the polymer compound described in paragraphs 0127 to 0129 of JP2013-249417A, the contents of which are incorporated into the present specification.

As the resin A2, graft copolymers in paragraphs 0037 to 0115 of JP2010-106268A (corresponding to paragraphs 0075 to 0133 of US2011/0124824) can also be used, the contents of which are incorporated into the present specification.

The dispersant may be used alone or in combination of two or more kinds thereof.

In a case where the composition contains a dispersant, a content of the dispersant (in a case where a plurality of types of dispersants are contained, the total content thereof) is preferably 0.001% to 20.0% by mass, more preferably 0.01% to 15.0% by mass, still more preferably 0.05% to 10.0% by mass, and particularly preferably 0.05% to 5.0% by mass with respect to the total mass of the composition.

In a case where the composition contains a dispersant, the content of the dispersant (in a case where a plurality of types of dispersants are contained, the total content thereof) is preferably 0.001% to 20.0% by mass, more preferably 0.01% to 15.0% by mass, still more preferably 0.05% to 10.0% by mass, and particularly preferably 0.05% to 5.0% by mass with respect to the total solid content of the composition.

### <Binder Component>

It is preferable that the composition contains a binder component selected from the group consisting of a resin and a resin precursor.

The binder component is a component different from the above-described rheology control agent (thixotropic agent).

The binder component may be a resin itself, or may be a precursor of the resin (resin precursor).

The resin precursor is a component capable of forming a resin by undergoing polymerization and/or crosslinking through a predetermined curing treatment with heat, light (such as ultraviolet light), or the like.

Examples of the resin precursor include a curable compound such as a thermosetting compound and a photocurable compound. In a case where the composition contains a resin precursor as a binder component, it is preferable that the composition further contains a curing agent, a curing accelerator, and the like.

From the viewpoint that the effect of the present invention is more excellent, the binder component preferably includes at least one of an epoxy compound or an oxetane compound, and more preferably contains an epoxy compound. The epoxy compound means a compound having one or more epoxy groups in the molecule, and the oxetane compound means a compound having one or more oxetanyl groups in the molecule.

In addition, in the epoxy compound, the epoxy group may be fused to a cyclic group (an alicyclic group or the like). The number of carbon atoms in the cyclic group which is fused with the epoxy group is preferably 5 to 15. In addition, in the above-described cyclic group, a portion other than the portion which is fused with the epoxy group may be monocyclic or polycyclic. In one cyclic group, only one epoxy group may be fused, or two or more epoxy groups may be fused.

In addition, in the oxetane compound, the oxetanyl group may be fused to a cyclic group (an alicyclic group or the like). The number of carbon atoms in the cyclic group which is fused with the oxetanyl group is preferably 5 to 15. In addition, in the above-described cyclic group, a portion other than the portion which is fused with the oxetanyl group may be monocyclic or polycyclic. In one cyclic group, only one oxetanyl group may be fused, or two or more oxetanyl groups may be fused.

The epoxy compound and the oxetane compound may be any of a monomer, an oligomer, or a polymer.

As the epoxy compound, a compound including 2 to 10 epoxy groups is preferable.

As the oxetane compound, a compound including 2 to 10 oxetanyl groups is preferable.

A molecular weight (or a weight-average molecular weight) of the epoxy compound and the oxetane compound is not particularly limited, but is, for example, preferably 2,000 or less.

Examples of the epoxy compound include an epoxy resin which is a glycidyl etherified product of a phenol compound, an epoxy resin which is a glycidyl etherified product of various novolac resins, an alicyclic epoxy resin, an aliphatic epoxy resin, a heterocyclic epoxy resin, a glycidyl ester-based epoxy resin, a glycidyl amine-based epoxy resin, an epoxy resin obtained by glycidylating halogenated phenols, a condensate of a silicon compound having an epoxy group and another silicon compound, and a copolymer of a polymerizable unsaturated compound having an epoxy group and another polymerizable unsaturated compound.

Examples of the epoxy compound include a monofunctional or polyfunctional glycidyl ether compound. Examples of the monofunctional or polyfunctional glycidyl ether compound also include glycidyl ether compounds of a polyhydric alcohol having 3 or higher valance, such as (poly)alkylene glycol diglycidyl ether, glycerol, sorbitol, and (poly)glycerol.

Examples of commercially available products of the epoxy compound and the oxetanyl compound include polyfunctional aliphatic glycidyl ether compounds such as DENACOL EX-212L, EX-214L, EX-216L, EX-321L, and EX-850L (all of which are Nagase ChemteX Corporation). These are low-chlorine products, but EX-212, EX-214, EX-216, EX-314, EX-321, EX-614, EX-850, and the like, which are not low-chlorine products, can also be used.

In addition, CELLOXIDE 2021P (manufactured by Daicel Corporation, polyfunctional epoxy monomer) and EHPE 3150 (manufactured by Daicel Corporation, polyfunctional epoxy/oxiranyl monomer) can also be used.

In addition, examples of a commercially available product of the epoxy resin include MARPROOF G-0150M, G-0105SA, G-0130SP, G-0250SP, G-10055, G-1005SA, G-1010S, G-2050M, G-01100, and G-01758 (manufactured by NOF Corporation).

In addition, examples of a commercially available product of the epoxy resin also include ADEKA RESIN EP-4000S, EP-4003S, EP-4010S, and EP-4011S (all of which are manufactured by ADEKA CORPORATION); NC-2000, NC-3000, NC-7300, XD-1000, EPPN-501, and EPPN-502 (all of which are manufactured by ADEKA CORPORATION); and JER1031S.

Specific examples of the bisphenol A-type epoxy resin and the bisphenol F-type epoxy resin include ZX1059 (manufactured by NIPPON STEEL Chemical & Material Co., Ltd.) and 828US (manufactured by Mitsubishi Chemical Corporation).

Examples of a commercially available product of the phenol novolac-type epoxy resin also include JER-157S65, JER-152, JER-154, and JER-157S70 (all of which are manufactured by Mitsubishi Chemical Corporation).

In addition, examples of a commercially available product of the epoxy compound also include ZX1658GS (liquid 1,4-glycidyl cyclohexane-type epoxy resin, manufactured by NIPPON STEEL Chemical & Material Co., Ltd.), HP-4700 (naphthalene-type tetrafunctional epoxy resin, manufactured by DIC Corporation), NC3000L (biphenyl-type epoxy resin, manufactured by Nippon Kayaku Co., Ltd.), or the like.

In addition, examples of a commercially available product of the oxetane compound also include Aron oxetane OXT-121, OXT-221, OX-SQ, and PNOX (all of which are manufactured by Toagosei Co., Ltd.).

In addition, with regard to a commercially available product of the epoxy compound, for example, the description in paragraph 0191 and the like of JP2012-155288A can be referred to, the contents of which are incorporated into the present specification.

In addition to the above, examples of the binder component include a (meth)acrylic resin, an ene-thiol resin, a polycarbonate resin, a polyether resin, a polyarylate resin, a polysulfone resin, a polyethersulfone resin, a polyphenylene resin, a polyarylene ether phosphine oxide resin, a polyimide resin, a polyamide imide resin, a polyolefin resin, a cyclic olefin resin, a polyester resin, a styrene resin, a phenoxy resin, and the like.

From the viewpoint of improving heat resistance, as the cyclic olefin resin, a norbornene resin is preferable. Examples of a commercially available product of the norbornene resin include ARTON series (for example, ARTON F4520) manufactured by JSR Corporation.

Examples of a commercially available product of the polyvinyl acetal resin include “KS-1” manufactured by SEKISUI CHEMICAL CO., LTD.

Examples of a commercially available product of the phenoxy resin include “YX7553BH30” (manufactured by Mitsubishi Chemical Corporation).

In addition, examples of a suitable aspect of the binder component also include resins described in Examples of WO2016/088645A.

In addition, examples of a suitable aspect of the binder component also include a resin which has an ethylenically unsaturated group (for example, a (meth)acryloyl group) in a side chain and in which a main chain and the ethylenically unsaturated group are bonded to each other through a divalent linking group to form an alicyclic structure.

In addition, examples of a suitable aspect of the binder component also include a resin having an acid group, a basic group, or an amide group. The resin having an acid group, a basic group, or an amide group is suitable from the viewpoint that the resin easily exhibits a function as a dispersant for dispersing the magnetic particles and the effect of the present invention is more excellent.

Examples of the acid group include a carboxy group, a phosphoric acid group, a sulfo group, and a phenolic hydroxyl group, and from the viewpoint that the effect of the present invention is more excellent, a carboxy group is preferable.

Examples of the basic group include an amino group (a group obtained by removing one hydrogen atom from ammonia, a primary amine, or a secondary amine) and an imino group.

Examples of a suitable aspect of the binder component also include a compound (hereinafter, also referred to simply as “ethylenically unsaturated compound”) which includes a group (hereinafter, also referred to as “ethylenically unsaturated group”) including an ethylenically unsaturated bond. A molecular weight (weight-average molecular weight) of the ethylenically unsaturated compound is preferably 2,000 or less.

As the ethylenically unsaturated compound, a compound including one or more ethylenically unsaturated bonds is preferable, a compound including two or more ethylenically unsaturated bonds is more preferable, a compound including three or more ethylenically unsaturated bonds is still more preferable, and a compound including five or more ethylenically unsaturated bonds is particularly preferable. The upper limit is, for example, 15 or less. Examples of the ethylenic unsaturated group include a vinyl group, a (meth)allyl group, and a (meth)acryloyl group.

Examples of the ethylenically unsaturated compound include dipentaerythritol triacrylate (as a commercially available product, KAYARAD D-330; manufactured by Nippon Kayaku Co., Ltd.), dipentaerythritol tetraacrylate (as a commercially available product, KAYARAD D-320; manufactured by Nippon Kayaku Co., Ltd.), dipentaerythritol penta(meth)acrylate (as a commercially available product, KAYARAD D-310; manufactured by Nippon Kayaku Co., Ltd.), and dipentaerythritol hexa(meth)acrylate (as a commercially available product, KAYARAD DPHA; manufactured by Nippon Kayaku Co., Ltd., and A-DPH-12E; manufactured by Shin-Nakamura Chemical Co., Ltd.). Oligomer types thereof can also be used.

In addition, examples thereof also include NK ESTER A-TMMT (pentaerythritol tetraacrylate, manufactured by Shin-Nakamura Chemical Co., Ltd.), and KAYARAD RP-1040, KAYARAD DPEA-12LT, KAYARAD DPHA LT, KAYARAD RP-3060, and KAYARAD DPEA-12 (all trade names, manufactured by Nippon Kayaku Co., Ltd.).

The ethylenically unsaturated compound may have an acid group such as a carboxylic acid group, a sulfonic acid group, and a phosphoric acid group. The ethylenically unsaturated compound including an acid group is preferably an ester of an aliphatic polyhydroxy compound and an unsaturated carboxylic acid, more preferably an ethylenically unsaturated compound having an acid group by reacting a nonaromatic carboxylic acid anhydride with an unreacted hydroxyl group of an aliphatic polyhydroxy compound, and still more preferably a compound in which the aliphatic polyhydroxy compound in the ester is pentaerythritol and/or dipentaerythritol. Examples of the commercially available product thereof include ARONIX TO-2349, M-305, M-510, and M-520, manufactured by Toagosei Co., Ltd.

The content of the binder component is preferably 1.0% to 24% by mass, more preferably 1.0% to 15% by mass, still more preferably 1.0% to 12% by mass, particularly preferably 1.0% to 10% by mass, and most preferably 1.0% to 7% by mass, with respect to the total mass of the composition.

The content of the binder component is preferably 1.0% to 24% by mass, more preferably 1.0% to 15% by mass, still more preferably 1.0% to 12% by mass, particularly preferably 1.0% to 10% by mass, and most preferably 1.0% to 7% by mass, with respect to the total solid content of the composition.

### <Curing Agent>

The composition may contain a curing agent. In particular, in a case where the above-described epoxy compound and/or oxetane compound is used, it is preferable to use the curing agent in combination.

Examples of the curing agent include a phenol-based curing agent, a naphthol-based curing agent, an acid anhydride-based curing agent, an active ester-based curing agent, a benzoxazine-based curing agent, a cyanate ester-based curing agent, a carbodiimide-based curing agent, and an amine adduct-based curing agent.

The curing agent may be used alone or in combination of two or more kinds thereof.

A content of the curing agent is preferably 0.001% to 3.5% by mass and more preferably 0.01% to 3.5% by mass with respect to the total mass of the composition.

The content of the curing agent is preferably 0.001% to 3.5% by mass and more preferably 0.01% to 3.5% by mass with respect to the total solid content of the composition.

### <Curing Accelerator>

The composition may contain a curing accelerator. In particular, in a case where the above-described compound having an epoxy group and/or an oxetanyl group is used, it is preferable to use the curing accelerator in combination.

Examples of the curing accelerator include a phosphate-based curing accelerator and an imidazole-based curing accelerator.

Examples of a commercially available product of the phosphate-based curing accelerator include HISHICOLIN PX-4MP (manufactured by Nippon Chemical Industrial CO., LTD.). In addition, examples of a commercially available product of the imidazole-based curing accelerator include 2E4MZ (manufactured by Shikoku Chemicals Corporation, 2-ethyl-4-methylimidazole).

The curing accelerator may be used alone or in combination of two or more kinds thereof.

A content of the curing accelerator is preferably 0.0002% to 3.0% by mass, more preferably 0.002% to 2.0% by mass, and still more preferably 0.01% to 1.0% by mass with respect to the total mass of the composition.

The content of the curing accelerator is preferably 0.0002% to 3.0% by mass, more preferably 0.002% to 2.0% by mass, and still more preferably 0.02% to 1.0% by mass with respect to the total solid content of the composition.

### <Adhesion Aid>

The composition may contain an adhesion aid.

As the adhesion aid, a silane coupling agent is preferable.

Examples of the silane coupling agent include N-phenyl-3-aminopropyltrimethoxysilane, phenyltrimethoxysilane, N-(2-aminoethyl)3-aminopropylmethyldimethoxysilane, N-(2-aminoethyl)3-aminopropylmethyltrimethoxysilane, 3-aminopropyltriethoxysilane, 3-mercaptopropyltrimethoxysilane, vinyltrimethoxysilane, N-(2-(vinylbenzylamino)ethyl)3-aminopropyltrimethoxysilane hydrochloride, 3-methacryloxypropyltrimethoxysilane, 3-chloropropylmethyldimethoxysilane, and 3-chloropropyltrimethoxysilane.

Examples of a commercially available product of the silane coupling agent include KBM series, KBE series, and the like (for example, KBM-573 and KBM-103) manufactured by Shin-Etsu Chemical Co., Ltd.

The silane coupling agent may be used alone or in combination of two or more kinds thereof.

A content of the adhesion aid is preferably 0.0002% to 3.0% by mass, more preferably 0.002% to 2.0% by mass, and still more preferably 0.01% to 1.0% by mass with respect to the total mass of the composition.

The content of the adhesion aid is preferably 0.0002% to 3.0% by mass, more preferably 0.002% to 2.0% by mass, and still more preferably 0.02% to 1.0% by mass with respect to the total solid content of the composition.

### <Other Components>

The composition may contain a component other than the above-described components (for example, a silicone oil, a polymerization initiator, a polymerization inhibitor, a sensitizer, a co-sensitizer, a surfactant, a plasticizer, an oil sensitizing agent, a filler, a rubber component, an antifoaming agent, a flame retardant, a peeling accelerator, an antioxidant, a fragrance, a surface tension adjuster, a chain transfer agent, and the like) may be used.

### <Manufacturing Method of Composition>

The composition can be prepared by mixing the respective components described above by known mixing methods (for example, mixing methods using a stirrer, a kneader, a homogenizer, a high-pressure emulsification device, a wet-type pulverizer, a wet-type disperser, or the like).

In a case of preparing the composition, the respective components may be formulated at once, or each of the components may be dissolved or dispersed in a solvent and then sequentially formulated. In addition, the input order and the operation conditions during the formulation are not particularly limited. For example, in a case where two or more other resins are used, the resins may be formulated together at once, or each resin may be formulated in batches.

Note that the prepared composition may be introduced into a predetermined container to form a composition container, or the composition container may be formed by introducing each component constituting the composition into the predetermined container to prepare the composition.

### <Use Application of Composition>

The composition accommodated in the composition container can be suitably used as a composition for forming a magnetic material, which is for forming a magnetic material.

A suitable example of the use application of the composition accommodated in the composition container is a use application as a composition for hole filling of a hole portion such as a via-hole or a through-hole provided in a circuit board. Examples of one specific procedure for hole filling include a method including the following steps 1 to 3.
Step 1: step of coating a substrate provided with a hole portion such as a via-hole and a through-hole with the composition by a known coating method such as, vacuum printing, a slit coating method, an ink jet method, a spin coating method, a cast coating method, a roll coating method or a screen printing method such that the hole portion is filled with the composition
Step 2: step of heating the composition in the substrate undergone the step 1, for example, at approximately 120° C. to 180° C. for approximately 30 to 90 minutes such that thermosetting components in the composition are cured
Step 3: step of removing unnecessary portions of the magnetic material obtained in the step 2 sticking out of a surface of the substrate by physical polishing such that the substrate has a flat surface

The circuit board including the above-described magnetic material is suitably used, for example, as an electronic component such as an antenna or an inductor provided in an electronic communication device or the like.

In addition, it is also preferable that the composition is formed into a film shape.

From the viewpoint of more excellent magnetic permeability, a film thickness of the film formed of the composition is preferably 1 to 10,000 μm, more preferably 10 to 1,000 μm, and still more preferably 15 to 800 μm.

The film formed of the composition is suitably used, for example, as an electronic component such as an antenna or an inductor provided in an electronic communication device or the like.

### EXAMPLES

Hereinafter, the present invention will be described in more detail based on the following examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed as being limited to Examples.

### [Preparation of Composition]

### [Various Components Used for Preparing Composition]

To make the composition, the components described in Table 2 were prepared. The components described in Table 2 are summarized below.

### <Magnetic Particles>

As the magnetic particles, P-1 to P-9 shown in Table 1 below were used. In Table 1, D10 and D90 are particle diameters of the magnetic particles corresponding to cumulative percentages of 10% and 90%, respectively, in the volume-based cumulative particle size distribution of the magnetic particles. The measuring method is as described above.

TABLE 1

| | | D90 | D10 |
|---|---|---|---|
| Number | Product name/composition | (μm) | (μm) |
| P-1 | Product name “AW2-08 PF-3F” | 6.3 | 1.7 |
| | (manufactured by EPSON ATMIX Corporation) | | |
| P-2 | Product name “AW2-08 PF-8F” | 9.8 | 2.6 |
| | (manufactured by EPSON ATMIX Corporation) | | |
| P-3 | product name “AW2-08 PF-20F” | 25.4 | 4.4 |
| | (manufactured by EPSON ATMIX Corporation) | | |
| P-4 | product name “80%Ni—4Mo PF-15F” | 19.1 | 3.3 |
| | (manufactured by EPSON ATMIX Corporation) | | |
| P-5 | product name “ATFINENC1 PF3FA” | 4.7 | 1.6 |
| | (manufactured by EPSON ATMIX Corporation) | | |
| P-6 | product name “EA-SMP-10 PF-5F” | 8.9 | 2.2 |
| | (manufactured by EPSON ATMIX Corporation) | | |
| P-7 | MnZn ferrite (synthetic product) | 59.1 | 19.9 |
| P-8 | NiZn ferrite (synthetic product) | 60.3 | 18.7 |
| P-9 | Mn ferrite (synthetic product) | 59.4 | 20.1 |

### <Rheology Control Agent>

S-1: product name “FLOWNON RCM-100” (fatty acid ester, manufactured by KYOEISHA CHEMICAL CO., LTD., concentration of solid contents: 100% by mass)
S-2: product name “Talen VA705B” (higher fatty acid amide, manufactured by KYOEISHA CHEMICAL CO., LTD., concentration of solid contents: 100% by mass)
S-3: product name “Disperbyk 111” (acidic dispersant, manufactured by BYK-Chemie GmbH, concentration of solid contents: 100% by mass)

### <Dispersant>

S-4: compound shown below (weight-average molecular weight: 10,000) (synthetic product, concentration of solid contents: 100% by mass). Note that a numerical value attached to each repeating unit of the main chain represents a mass ratio, and a numerical value attached to the side chain represents a repetition number

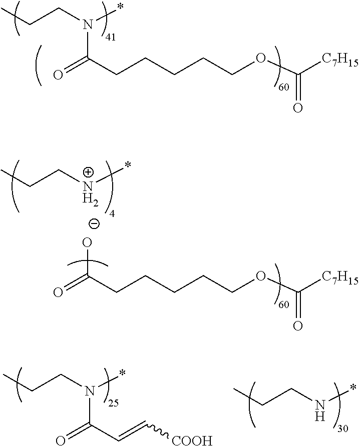

<Epoxy Compound and/or Oxetane Compound>
S-5: product name “828US” (bisphenol A-type epoxy resin, manufactured by Mitsubishi Chemical Corporation, concentration of solid contents: 100% by mass)
L-1: product name “DENACOL EX-314” (glycerol polyglycidyl ether, manufactured by Nagase ChemteX Corporation, concentration of solid contents: 100% by mass)
L-2: product name “DENACOL EX-512” (polyglycerol polyglycidyl ether, manufactured by Nagase ChemteX Corporation, concentration of solid contents: 100% by mass)

### <Curing Agent/Curing Accelerator>

S-6: product name “HISHICOLIN PX-4MP” (phosphate-based epoxy curing accelerator, manufactured by Nippon Chemical Industrial CO., LTD., concentration of solid contents: 100% by mass)
S-7: product name “2E4MZ” (2-ethyl-4-methylimidazole (curing accelerator), manufactured by SHIKOKU CHEMICALS CORPORATION, concentration of solid contents: 100% by mass)

### <Filler>

S-8: product name “SO-C2” (silica particles, manufactured by Admatechs, concentration of solid contents: 100% by mass)

### <Silane Coupling Agent>

S-9: product name “KBM-573” (N-phenyl-3-aminopropyltrimethoxysilane, manufactured by Shin-Etsu Chemical Co., Ltd., concentration of solid contents: 100% by mass)

### <Solvent>

L-4: PGMEA (propylene glycol monomethyl ether acetate, manufactured by Tokyo Chemical Industry Co., Ltd.)
L-5: 1,6-HDDA (1,6-hexanediol diacetate, manufactured by Daicel Corporation)
L-6: glycerol triacetate (manufactured by FUJIFILM Wako Pure Chemical Corporation)
L-7: cyclohexanone (manufactured by FUJIFILM Wako Pure Chemical Corporation)

### [Preparation of Composition Container]

Components described in Table 2, other than the solvent, were mixed to have the composition (parts by mass) shown in Table 2, and the mixture was put into the following container. Subsequently, the solvent was added thereto to have composition (parts by mass) shown in Table 2, the container was sealed, and the mixture was dispersed at 50 G for 1 hour using a low frequency resonance acoustic mixer (RAM) manufactured by Resodyn Acoustic Mixers, Inc., thereby preparing a composition container.

### (Container)

The container of the composition container is as follows.

### “Container 1”

The container 1 corresponds to the container 12A of the composition container in FIG. 1 described above, and the specific configuration thereof is as follows.
Inner diameter of opening portion 20A: 108 mm
Area of opening portion 20A: 9156 mm²
Maximum value of area surrounded by contour line of inner wall surface 22A of container 12A in cross section orthogonal to height direction DA of container 12A: 9156 mm²
Inclination at height H/2: described in table
Height of body portion 16A of container 12A: 128 mm
Material of container 12A: PE
Inner volume of container 12A: 1050 mL
Void ratio: 10% by volume
Atmosphere gas in space: mixed gas of nitrogen and oxygen (oxygen partial pressure: 204 hPa)
   “Containers 2a to 2c”

### (Container 2a)

The container 2a corresponds to the container 12A of the composition container in FIG. 1 described above, and the specific configuration thereof is as follows.
Inner diameter of opening portion 20A: 84 mm
Area of opening portion 20A: 5539 mm²
Maximum value of area surrounded by contour line of inner wall surface 22A of container 12A in cross section orthogonal to height direction DA of container 12A: 6154 mm²
Inclination at height H/2: described in table
Height of body portion 16A of container 12A: 140 mm
Material of container 12A: PE
Inner volume of container 12A: 860 mL
Void ratio: 10% by volume
Atmosphere gas in space: mixed gas of nitrogen and oxygen (oxygen partial pressure: 204 hPa)

### (Containers 2b and 2c)

The containers 2b and 2c correspond to the container 12A of the composition container in FIG. 1 described above.

The containers 2b and 2c have the same configuration as the container 2a except that the inner diameter of the opening portion of mouth-neck portion of the container 2a is changed such that the opening area ratio is the numerical value shown in Table 2.

“Containers 3a to 3e”

### (Container 3a)

The container 3a corresponds to the container 12C of the composition container in FIG. 6 described above, and the specific configuration thereof is as follows.
Inner diameter of opening portion 20C: 120 mm
Area of opening portion 20C: 11304 mm²
Maximum value of area surrounded by contour line of inner wall surface 22C of container 12C in cross section orthogonal to height direction DC of container 12C: 11304 mm²
Inclination at height H/2: described in table
Height of body portion 16C of container 12C: 102 mm
Material of container 12C: PE
Inner volume of container 12C: 1150 mL
Void ratio: 10% by volume
Atmosphere gas in space: mixed gas of nitrogen and oxygen (oxygen partial pressure: 204 hPa)

### (Containers 3b to 3e)

The configuration is the same as that of the container 3a except that the inclination of the inner wall surface 22C of the container 3a is changed such that the inclination at the height H/2 is the numerical value shown in Table 2.

### [Evaluation]

After allowing each of the prepared composition containers of Examples and Comparative Examples to stand at −15° C. for 6 months, the following evaluations (Evaluation 1 and 2) were carried out.

### [Evaluation 1: Evaluation of Stirring Suitability by Stirring Blade]

A stirring blade having a size just enough to pass through the opening portion of the container was put into the container accommodated in each composition, and stirring was carried out at 300 rpm for 15 minutes.

An Si wafer having a thickness of 100 μm was coated with CT4000 (manufactured by FUJIFILM Electronic Materials Co., Ltd.) to produce a substrate. Next, 10 g of the above-described composition after stirring was taken out in order from the liquid level side onto the produced substrate with a spatula, and a sample substrate for measurement (sample substrates for measurement 1 to N) was formed for each of the taken-out compositions according to the following procedure.

Specifically, each composition was applied with an applicator having a gap of 100 μm, dried by Bake at 100° C. for 120 seconds, and then heated at 230° C. for 15 minutes to completely cure the film. Next, the obtained cured film was cut into pieces having a size of 1 cm×2.8 cm for each substrate, thereby obtaining a sample substrate for measurement.

The magnetic properties of these substrates were measured at 60 MHz using PER-01 (manufactured by KEYCOM Corporation), and a relative magnetic permeability μ′A (relative magnetic permeability μ′A₁ to μ′A_{N}) was obtained for each sample substrate for measurement. Next, the maximum value and the minimum value of the relative magnetic permeability μ′A were extracted as μ′Amax and μ′Amin, respectively, and the evaluation of the stirring suitability was performed based on the value of Δμ′ in a case where μ′Amax−μ′Amin=Δμ′. From the viewpoint of practicality, the evaluation result is preferably “2” or more, and more preferably “3”. The results are shown in Table 2.

### <Evaluation Standard>

“3”: Δμ′<3
“2”: 3≤Δμ′<5
“1”: 5≤Δμ′
   [Evaluation 2: Evaluation of Stirring Suitability with Rotating and Revolving Mixer]

Each composition container was set in a rotating and revolving mixer (“Planetary centrifugal vacuum mixer)”, manufactured by Shinki Co., Ltd., ARE-310) and stirred at 500 rpm.

An Si wafer having a thickness of 100 μm was coated with CT4000 (manufactured by FUJIFILM Electronic Materials Co., Ltd.) to produce a substrate. Next, 10 g of the above-described composition after stirring was taken out in order from the liquid level side onto the produced substrate with a spatula, and a sample substrate for measurement (sample substrates for measurement 1 to N) was formed for each of the taken-out compositions according to the following procedure.

Specifically, each composition was applied with an applicator having a gap of 100 μm, dried by Bake at 100° C. for 120 seconds, and then heated at 230° C. for 15 minutes to completely cure the film. Next, the obtained cured film was cut into pieces having a size of 1 cm×2.8 cm for each substrate, thereby obtaining a sample substrate for measurement.

The magnetic properties of these substrates were measured at 60 MHz using PER-01 (manufactured by KEYCOM Corporation), and a relative magnetic permeability μ′A (relative magnetic permeability μ′A₁ to μ′A_{N}) was obtained for each sample substrate for measurement. Next, the maximum value and the minimum value of the relative magnetic permeability μ′A were extracted as μ′Amax and μ′Amin, respectively, and the evaluation of the stirring suitability was performed based on the value of Δμ′ in a case where μ′Amax−μ′Amin=Δμ′. From the viewpoint of practicality, the evaluation result is preferably “2” or more, and more preferably “3”. The results are shown in Table 2.

### <Evaluation Standard>

“3”: Δμ′<3
“2”: 3≤Δμ′<5
“1”: 5≤Δμ′

Table 2 is shown below.

In the table, the unit of the content of each component of the composition is part by mass.

In the table, “Proportion of particles having a particle diameter of 1 μm or more (% by volume)” and “D90/D10” in the column of “Characteristics of magnetic particles” are determined according to the above-described measuring method.

In the table, “(D90/D10)\hat{ }2 ” is intended to be the square of (D90/D10).

In the table, “cos(90−W)°×(D90/D10)²” corresponds to the left side of the inequality of Formula (C1) described above.

In the table, the value in the column of “Viscosity of composition” is a viscosity measured under conditions of a temperature of 25° C. and a shear rate of 0.1 sec⁻¹.

TABLE 2

| | | | | | | | | | Characteristics of | | | | | | | | |
|---|---|---|---|---|---|---|---|---|---|---|---|---|---|---|---|---|---|
| | | | | | | | | | magnetic particles | | | | | | | Evaluation result | |
| | | | | | | | | | Proportion | | | | | | | | Evaluation |
| | | | | | | | | | of particles | | | | | | | Evaluation | of stirring |
| | | Composition of composition (parts by mass) | | | | | | | having particle | | | Container configuration | | | | of stirring | suitability |
| | | Magnetic | | Solid | | Liquid | | | diameter of 1 | | Viscosity of | | | | cos | suitability | using rotating |
| | | particles | | component | | component | | Total | μm or more | | composition | Type of | Opening | inclination | (90 − W) × | using stirring | and revolving |
| | | Type | Content | Type | Content | Type | Content | content | (% by volume) | D90/D10 | (Pa · s) | container | area ratio | (W°) | (D90/D10)\hat{ }2 | blade | mixer |
| Table 2 (part 1) | | | | | | | | | | | | | | | | | |
| Example | 1 | P-1 | 85.6 | S-1 | 0.3 | L-1 | 5.1 | 100 | >99 | 3.7 | 3 | 1 | 1.0 | 0 | 0.00 | 3 | 3 |
| | | | | S-4 | 0.6 | L-4 | 8.4 | | | | | | | | | | |
| Example | 2 | P-1 | 85.6 | S-1 | 0.3 | L-1 | 5.1 | 100 | >99 | 3.7 | 3 | 2a | 0.9 | 0 | 0.00 | 3 | 3 |
| | | | | S-4 | 0.6 | L-4 | 8.4 | | | | | | | | | | |
| Example | 3 | P-1 | 85.6 | S-1 | 0.3 | L-1 | 5.1 | 100 | >99 | 3.7 | 3 | 2b | 0.8 | 0 | 0.00 | 2 | 3 |
| | | | | S-4 | 0.6 | L-4 | 8.4 | | | | | | | | | | |
| Comparative | 1 | P-1 | 85.6 | S-1 | 0.3 | L-1 | 5.1 | 100 | >99 | 3.7 | 3 | 2c | 0.7 | 0 | 0.00 | 1 | 3 |
| example | | | | S-4 | 0.6 | L-4 | 8.4 | | | | | | | | | | |
| Example | 4 | P-1 | 85.6 | S-1 | 0.3 | L-1 | 5.1 | 100 | >99 | 3.7 | 3 | 3a | 1.0 | 10 | 2.38 | 3 | 3 |
| | | | | S-4 | 0.6 | L-4 | 8.4 | | | | | | | | | | |
| Example | 5 | P-1 | 85.6 | S-1 | 0.3 | L-1 | 5.1 | 100 | >99 | 3.7 | 3 | 3b | 1.0 | 20 | 4.68 | 3 | 3 |
| | | | | S-4 | 0.6 | L-4 | 8.4 | | | | | | | | | | |
| Comparative | 2 | P-1 | 85.6 | S-1 | 0.3 | L-1 | 5.1 | 100 | >99 | 3.7 | 3 | 3c | 1.0 | 25 | 5.79 | 3 | 1 |
| example | | | | S-4 | 0.6 | L-4 | 8.4 | | | | | | | | | | |
| Example | 6 | P-3 | 85.6 | S-1 | 0.3 | L-1 | 5.1 | 100 | >99 | 5.8 | 3 | 3d | 1.0 | 7.5 | 4.39 | 3 | 3 |
| | | | | S-4 | 0.6 | L-4 | 8.4 | | | | | | | | | | |
| Example | 7 | P-3 | 85.6 | S-1 | 0.3 | L-1 | 5.1 | 100 | >99 | 5.8 | 3 | 3a | 1.0 | 10 | 5.84 | 3 | 2 |
| | | | | S-4 | 0.6 | L-4 | 8.4 | | | | | | | | | | |
| Example | 8 | P-6 | 85.6 | S-1 | 0.3 | L-1 | 5.1 | 100 | >99 | 4.0 | 3 | 3e | 1.0 | 15 | 4.14 | 3 | 3 |
| | | | | S-4 | 0.6 | L-4 | 8.4 | | | | | | | | | | |
| Example | 9 | P-6 | 85.6 | S-1 | 0.3 | L-1 | 5.1 | 100 | >99 | 4.0 | 3 | 3b | 1.0 | 20 | 5.47 | 3 | 2 |
| | | | | S-4 | 0.6 | L-4 | 8.4 | | | | | | | | | | |
| Example | 10 | P-1 | 42.8 | S-1 | 0.3 | L-2 | 5.1 | 100 | >99 | 22.1 | 3 | 1 | 1.0 | 0 | 0.00 | 3 | 3 |
| | | P-7 | 42.8 | S-4 | 0.6 | L-5 | 8.4 | | | | | | | | | | |
| Table 2 (part 2) | | | | | | | | | | | | | | | | | |
| Example | 11 | P-5 | 42.8 | S-2 | 0.3 | L-1 | 2.5 | 100 | >99 | 23.1 | 3 | 1 | 1.0 | 0 | 0.00 | 3 | 3 |
| | | P-8 | 42.8 | S-4 | 0.6 | L-2 | 2.6 | | | | | | | | | | |
| | | | | | | L-6 | 8.4 | | | | | | | | | | |
| Example | 12 | P-6 | 42.8 | S-3 | 0.3 | L-1 | 1 | 100 | >99 | 18.2 | 3 | 1 | 1.0 | 0 | 0.00 | 3 | 3 |
| | | P-9 | 42.8 | S-4 | 0.6 | L-2 | 4.1 | | | | | | | | | | |
| | | | | | | L-7 | 8.4 | | | | | | | | | | |
| Example | 13 | P-2 | 85.6 | S-1 | 0.3 | L-1 | 5.1 | 100 | >99 | 3.8 | 3 | 1 | 1.0 | 0 | 0.00 | 3 | 3 |
| | | | | S-4 | 0.6 | L-4 | 8.4 | | | | | | | | | | |
| Example | 14 | P-4 | 85.6 | S-1 | 0.3 | L-1 | 5.1 | 100 | >99 | 5.8 | 3 | 1 | 1.0 | 0 | 0.00 | 3 | 3 |
| | | | | S-4 | 0.6 | L-4 | 8.4 | | | | | | | | | | |
| Example | 15 | P-1 | 28.5 | S-1 | 0.3 | L-1 | 5.2 | 100 | >99 | 6.7 | 3 | 1 | 1.0 | 0 | 0.00 | 3 | 3 |
| | | P-2 | 28.5 | S-4 | 0.6 | L-4 | 8.4 | | | | | | | | | | |
| | | P-3 | 28.5 | | | | | | | | | | | | | | |
| Example | 16 | P-1 | 85.6 | S-1 | 0.1 | L-1 | 5 | 100 | >99 | 3.7 | 3 | 1 | 1.0 | 0 | 0.00 | 3 | 3 |
| | | | | S-2 | 0.1 | L-4 | 2.1 | | | | | | | | | | |
| | | | | S-3 | 0.1 | L-5 | 2.1 | | | | | | | | | | |
| | | | | S-4 | 0.6 | L-6 | 2.1 | | | | | | | | | | |
| | | | | S-6 | 0.1 | L-7 | 2.1 | | | | | | | | | | |
| Example | 17 | P-1 | 85.6 | S-1 | 0.3 | L-1 | 13.2 | 100 | >99 | 3.7 | 3 | 1 | 1.0 | 0 | 0.00 | 3 | 3 |
| | | | | S-4 | 0.6 | | | | | | | | | | | | |
| | | | | S-7 | 0.1 | | | | | | | | | | | | |
| | | | | S-8 | 0.1 | | | | | | | | | | | | |
| | | | | S-9 | 0.1 | | | | | | | | | | | | |
| Example | 18 | P-1 | 85.6 | S-1 | 0.3 | L-1 | 3.1 | 100 | >99 | 3.7 | 3 | 1 | 1.0 | 0 | 0.00 | 3 | 3 |
| | | | | S-4 | 0.6 | L-4 | 2.1 | | | | | | | | | | |
| | | | | S-5 | 2 | L-5 | 2.1 | | | | | | | | | | |
| | | | | | | L-6 | 2.1 | | | | | | | | | | |
| | | | | | | L-7 | 2.1 | | | | | | | | | | |
| Example | 19 | P-1 | 82.8 | S-1 | 0.3 | L-1 | 7.9 | 100 | >99 | 3.7 | 2 | 1 | 1.0 | 0 | 0.00 | 3 | 3 |
| | | | | S-4 | 0.6 | L-4 | 8.4 | | | | | | | | | | |
| Example | 20 | P-1 | 88.4 | S-1 | 0.3 | L-1 | 2.3 | 100 | >99 | 3.7 | 2 | 1 | 1.0 | 0 | 0.00 | 3 | 3 |
| | | | | S-4 | 0.6 | L-4 | 8.4 | | | | | | | | | | |

From the results in the table, it was found that, in the composition container of Examples, a variation in relative magnetic permeability is less likely to occur between magnetic materials obtained in a case where the composition accommodated in the container is stirred and then gradually taken out from the container and the composition is used for producing the magnetic materials.

In addition, from the comparison of Examples, it was confirmed that in a case where the composition container satisfies Formula (C1), the above-described effect is further improved.

On the other hand, the composition containers in Comparative Examples did not obtain the desired effect.

In addition, in a case where the composition container was produced (Examples 1A to 20A) by the same procedure as in Examples 1 to 20 except that a container in which the inner diameter of the body portion and/or the height of the body portion was changed was used, and the same evaluation of stirring suitability as in Examples 1 to 20 was performed, the same tendency of the evaluation results as in Examples 1 to 20 was obtained.

In addition, in Examples 1 to 20, it was confirmed that, in a case where the composition container was allowed to stand at −15° C. for 6 months by changing the oxygen partial pressure of the void portion of the container in the composition container, the lower the oxygen partial pressure, the more excellent the temporal stability of the composition.

### EXPLANATION OF REFERENCES

10A, 10A′, 10B, 10C: composition container
12A, 12A′, 12B, 12C: container
13A, 13B, 13C: composition
14A, 14B, 14C: bottom surface of container
16A, 16B, 16C: body portion
18A, 18B, 18C: mouth-neck portion
20A, 20B, 20C: opening portion of container
L1A, L1B, L1C: diameter of opening portion
L2A, L2B: diameter of bottom surface
L2C: diameter at height position farthest from bottom surface 14C
22A, 22B, 22C: inner wall surface
24A: contour line
DA, DB, DC: height direction of container
H: height in container at which composition is present
W1B, W1C: angle

What is claimed is:

1. A composition container comprising:
a container having an opening portion; and
a composition that is accommodated inside the container and contains magnetic particles and a liquid component,
wherein a viscosity of the composition measured under conditions of a temperature of 25° C. and a shear rate of 0.1 sec⁻¹ is 1 to 1,000 Pa·s,
a content of the magnetic particles having a particle diameter of 1 μm or more is 80% by volume or more with respect to a total volume of the magnetic particles,
a ratio of an area of the opening portion of the container to a maximum area of an areas surrounded by a contour line of an inner wall surface of the container in a cross section orthogonal to a height direction of the container is 0.8 or more and 1.0 or less, and
an angle W of an inclination of the inner wall surface of the container with respect to the height direction of the container at a height position of half of a height H in the container at which the composition is present is 20° or less.

2. The composition container according to claim 1,
wherein in a volume-based cumulative particle size distribution of the magnetic particles, in a case where particle diameters of the magnetic particles corresponding to a cumulative percentage of 10% and 90% are respectively denoted by D10 and D90, D90/D10≥3.7 is satisfied, and
W, D10, and D90 satisfy Formula (C1),
Formula (C1): cos(90−W)°×(D90/D10)²≤5.00.

3. The composition container according to claim 1,
wherein the composition container contains two or more kinds of the magnetic particles having different compositions.

4. The composition container according to claim 1,
wherein an inner volume of the container is 2 L or less.

5. The composition container according to claim 1,
wherein a void ratio calculated by Formula (C2) is 50% by volume or less,
Void ratio=(a volume of a void portion obtained by subtracting a volume occupied by the composition from the inner volume of the container/the inner volume of the container)×100. Formula (C2):

6. The composition container according to claim 5,
wherein in a composition of an atmosphere gas in the void portion, an oxygen partial pressure (hPa) is 204 hPa or less.

7. The composition container according to claim 1,
wherein the liquid component contains a solvent, and
a content of the solvent is 5.0% by mass or more with respect to a total mass of the composition.

8. The composition container according to claim 1,
wherein the magnetic particles include soft magnetic particles.

9. The composition container according to claim 1,
wherein the magnetic particles are spherical.

10. The composition container according to claim 1,
wherein the composition is a composition for forming a magnetic material.

11. The composition container according to claim 10,
wherein the composition is a composition for forming a magnetic material that is used for forming an electronic component.

12. The composition container according to claim 10,
wherein the composition is a composition for forming a magnetic material that is used for forming an inductor.

13. The composition container according to claim 10,
wherein the composition is a composition for forming a magnetic material that is used for forming an antenna.

14. The composition container according to claim 2,
wherein the composition container contains two or more kinds of the magnetic particles having different compositions.

15. The composition container according to claim 2,
wherein an inner volume of the container is 2 L or less.

16. The composition container according to claim 2,
wherein a void ratio calculated by Formula (C2) is 50% by volume or less,
Void ratio=(a volume of a void portion obtained by subtracting a volume occupied by the composition from the inner volume of the container/the inner volume of the container)×100. Formula (C2):

17. The composition container according to claim 16,
wherein in a composition of an atmosphere gas in the void portion, an oxygen partial pressure (hPa) is 204 hPa or less.

18. The composition container according to claim 2,
wherein the liquid component contains a solvent, and
a content of the solvent is 5.0% by mass or more with respect to a total mass of the composition.

19. The composition container according to claim 2,
wherein the magnetic particles include soft magnetic particles.

20. The composition container according to claim 2,
wherein the magnetic particles are spherical.
